(19) United States
(12) Patent Application Publication
(10) Pub. No.: US 2022/0242098 A1
(43) Pub. Date: Aug. 4, 2022

(54) HYBRID FLEX ARMOURED COMPOSITES

(71) Applicant: ARMOURED ONE GLASS, LLC, SYRACUSE, NY (US)

(72) Inventors: GIAMBATTISTA AMODEI, PHOENIX, NY (US); SEAN R. RANCIER, LIVERPOOL, NY (US)

(73) Assignee: ARMOURED ONE GLASS, LLC, SYRACUSE, NY (US)

(21) Appl. No.: 17/591,580

(22) Filed: Feb. 2, 2022

Related U.S. Application Data
(60) Provisional application No. 63/144,826, filed on Feb. 2, 2021.

(51) Int. Cl. B32B 17/10

(52) U.S. Cl. CPC B32B 17/10788; B32B 17/10036; B32B 17/10128; B32B 2605/006; B32B 17/10816; B32B 2307/412; B32B 2307/558; B32B 17/1088

(57) ABSTRACT

Multi-layered protective glass systems which utilize dissimilar materials combined to form a thin armored composite configuration are disclosed. Aspects of embodiments of the present invention contemplate the use of various materials, configurations of layers and interlayer thicknesses each of which is consistent or needed for use in different applications such as automobiles, buildings, etc.

### CROSS-REFERENCE TO RELATED APPLICATIONS AND PRIORITY CLAIMS

This patent application is a Non-Provisional patent application and claims priority under 35 U.S.C. § 119(e) to U.S. Provisional Patent Application Ser. No. 63/144,826, titled “HYBRID FLEX ARMOURED COMPOSITES” filed Feb. 2, 2021. The entire disclosure of the aforementioned patent application is incorporated by reference as if fully stated herein.

### FIELD OF THE INVENTION

The present invention is directed to a protective glass system, and, more particularly, to a protective glass system having a multi-layered configuration designed to slow and/or resist blunt force attacks while also providing bullet resistant protection.

### BACKGROUND & SUMMARY OF THE INVENTION

Smash and grab theft, car hijacking, and shootings are on the rise and often occurs to many passenger vehicles across the world. Businesses, schools, and government facilities require various levels of protection for bullet resistance, shooter attack, hurricane, and impact resistance. Often these glass systems require special framing and utilize very thick pieces of glass. Thick pieces of glass require large amounts of energy to manufacture from start to finish. Traditional interlayers must be stored in very strict climate-controlled rooms 24/7 that consume large amounts of energy. Polyvinyl butanol and ionomers like SentryGlas use thick pieces of glass due to the poor water and impact resistance under various climates. Using traditional interlayers that need any sort of protection requires extra energy to produce it in an autoclave or lamination oven because of its extended bake times. The cold climates also affect the interlayers that use the existing technology because they become brittle. Brittle interlayers are not optimal for impact or ballistic applications. While windshields are heavily regulated for safety in case of accidents, side windows and roof glass are often an afterthought with virtually no safety features in case of hijackings, shootings, and blunt attacks. Most windows in cars are equipped with a single layer of tempered glass which offers little to no protection for the vehicle and the occupants. When tempered glass is shot, the glass will fall apart immediately and leave the vehicle and occupants exposed for an attacker to gain entry.

To date, no automotive company in the world has created a thin glass for passenger vehicles which could slow an attacker or be bullet resistant for civilian use without using polycarbonate layers that degrade in a short amount of time. As such, there is a need for a thin glass system for use in passenger vehicles which would slow an attacker's blunt force attacks. There is also a need for a thin glass system that provides bullet resistant protection for civilian use without using polycarbonate layers that degrade in a short amount of time. Further still, because building invasions occur when assailants gain access by smashing entry and egress points that may include glass fixtures, there also exists a need for a protective glass system for use in these applications.

Current technology for glass in many applications utilizes a single layer of tempered glass. Tempered glass, being the most common glass configuration on the market, can take one hit before it shatters, with nothing to protect the occupants of, say, a vehicle from anything further. After one bullet from any gun, it will shatter immediately leaving the vehicle and its occupants defenseless. In addition, with one hit from a blunt object, tempered glass will shatter into small pieces and leave a very large hole enabling an attacker to either steal the vehicle or harm its occupants.

Aspects of embodiments of the present invention contemplate a multi-layered protective glass system which: (1) can fully stop bullets (depending on the composition of the glass makeup) (2) stop an intruder from physically breaking in with other weapons, and (3) remain intact with no spalling. Some companies use polycarbonates for military vehicles because they can be made very thick (20+mm). However, polyvinyl butyral (PVB) and polycarbonate (PCB) based glass systems become mechanically, optically, and thermally unstable after a couple years. While other companies use one layer of glass, aspects of embodiments of the present invention uses, inter alia, 16 layers of glass and polymeric materials to create a thin armored glass never used in a commercial vehicle before.

### SUMMARY OF THE INVENTION

Aspects of embodiments of the present invention contemplate the use of a multi-layered protective glass system which utilizes dissimilar materials combined to form a thin armored composite configuration. Aspects of embodiments of the present invention also contemplate the use of various interlayer thicknesses each of which is consistent or needed for use in different applications such as automobiles, buildings, etc.

An aspect of an embodiment of the present invention contemplates a multi-layered protective glass system, which may include: a first layer of glass, a first hybrid interlayer, comprising of first and second sides, where the first layer of glass may be superimposed on the first side of the first hybrid interlayer, a second layer of glass, comprising of first and second sides, where the second side of the first hybrid interlayer may be superimposed on the first side of the second layer of glass, a second hybrid interlayer, comprising of first and second sides, where the second side of the second layer of glass may be superimposed on the first side of the second hybrid interlayer, a third layer of glass, comprising of first and second sides, where the second side of the second hybrid interlayer may be superimposed on the first side of the third layer of glass, and an anti-spalling layer, comprising of first and second sides, where the second side of the third layer of glass may be superimposed on the first side of the anti-spalling layer.

In an aspect of an embodiment of the present invention, the first hybrid interlayer of the multi-layered protective glass system may comprise of two layers of ethylene vinyl acetate (EVA), and a layer of modified polyethylene (MPE).

In an aspect of an embodiment of the present invention, the layer of modified polyethylene may be interposed between the two layers of ethylene vinyl acetate (EVA).

In an aspect of an embodiment of the present invention, the second hybrid interlayer may comprise of two layers of ethylene vinyl acetate (EVA), and a layer of modified polyethylene (MPE).

In an aspect of an embodiment of the present invention, the layer of modified polyethylene may be interposed between the two layers of ethylene vinyl acetate (EVA).

In an aspect of an embodiment of the present invention, the anti-spalling layer may comprise of: first, second and third layers of pressure sensitive adhesive and first, second and third layers of polyethylene terephthalate (PET).

In an aspect of an embodiment of the present invention, the first layer of pressure sensitive adhesive (PSA) may be superimposed on the first layer of polyethylene terephthalate (PET), which in turn may be superimposed on the second layer of pressure sensitive adhesive (PSA), which in turn may be superimposed on the second layer of polyethylene terephthalate (PET), which in turn may be superimposed on the third layer of pressure sensitive adhesive, which in turn may be superimposed on the third layer of polyethylene terephthalate (PET). In an aspect of an embodiment of the present invention, a portion of the first layer of pressure sensitive adhesive may form the first side of the anti-spalling layer while a portion of the third layer of polyethylene terephthalate (PET) may form the second side of the anti-spalling layer.

In an aspect of an embodiment of the present invention, the multi-layered protective glass system may further comprise of a layer of ethylene vinyl acetate (EVA), where the layer of ethylene vinyl acetate (EVA) may be interposed between the 3rd glass layer and the anti-spalling layer.

In an aspect of an embodiment of the present invention, the multi-layered protective glass system may further comprise of a layer of self-healing surface coat (SHSC), where the layer of SHSC may be superimposed on the second side of the anti-spalling layer.

In an aspect of an embodiment of the present invention, any one or more of the first, second and third layers of glass may be any one of: borosilicate glass, annealed glass, heat strengthened glass, tempered glass.

Another aspect of an embodiment of the present invention contemplates a multi-layered protective glass system, which may include: a first layer of glass, a hybrid interlayer, comprising of first and second sides, where the first layer of glass may be superimposed on the first side of the hybrid interlayer, a second layer of glass, comprising of first and second sides, where the second side of the hybrid interlayer may be superimposed on the first side of the second layer of glass, an anti-spalling layer, comprising of first and second sides, where the second side of the second layer of glass may be superimposed on the first side of the anti-spalling layer, and a layer of self-healing surface coat (SHSC), where the layer of SHSC may be superimposed on the second side of the anti-spalling layer.

In another aspect of an embodiment of the present invention, the anti-spalling layer may comprise of: first, second and third layers of pressure sensitive adhesive (PSA) and first, second and third layers of polyethylene terephthalate (PET), where a portion of the first layer of PSA may form the first side of the anti-spalling layer while a portion of the third layer of PET may form the second side of the anti-spalling layer.

In another aspect of an embodiment of the present invention, the hybrid interlayer may comprise of two layers of ethylene vinyl acetate (EVA), and a layer of modified polyethylene (MPE).

In another aspect of an embodiment of the present invention, the layer of modified polyethylene may be interposed between the two layers of ethylene vinyl acetate (EVA).

In another aspect of an embodiment of the present invention, the first layer of pressure sensitive adhesive may be superimposed on the first layer of polyethylene terephthalate (PET), which in turn may be superimposed on the second layer of pressure sensitive adhesive, which in turn may be superimposed on the second layer of polyethylene terephthalate (PET), which in turn may be superimposed on the third layer of pressure sensitive adhesive, which in turn may be superimposed on the third layer of polyethylene terephthalate (PET).

In another aspect of an embodiment of the present invention, any one or both of the first and second layers of glass may be any one of: borosilicate glass, annealed glass, heat strengthened glass, tempered glass.

A further aspect of an embodiment of the present invention contemplates a multi-layered protective glass system, comprising: at least one layer of glass, a hybrid interlayer, comprising of first and second sides, where a first layer of said at least one layer of glass may be superimposed on the first side of the hybrid interlayer, a second layer of said at least one layer of glass, comprising of first and second sides, where the second side of the hybrid interlayer may be superimposed on the first side of the second layer of said at least one layer of glass, a layer of ethylene vinyl acetate (EVA), comprising of first and second sides, where the second side of the second layer of glass may be superimposed on the first side of the layer of ethylene vinyl acetate (EVA), an anti-spalling layer, comprising of first and second sides, where the second side of the layer of ethylene vinyl acetate (EVA) may be superimposed on the first side of the anti-spalling layer, and a layer of self-healing surface coat (SHSC), where the layer of SHSC may be superimposed on the second side of the anti-spalling layer.

In a further aspect of an embodiment of the present invention, the hybrid interlayer may comprise of two layers of ethylene vinyl acetate (EVA), and a layer of modified polyethylene (MPE).

In a further aspect of an embodiment of the present invention, the layer of modified polyethylene may be interposed between the two layers of ethylene vinyl acetate (EVA).

In a further aspect of an embodiment of the present invention, the anti-spalling layer may comprise of: first, second and third layers of polyethylene terephthalate (PET), and first and second layers of pressure sensitive adhesive (PSA) and where a portion of the first layer of polyethylene terephthalate (PET) forms the first side of the anti-spalling layer and where a portion of the third layer of polyethylene terephthalate (PET) forms the second side of the anti-spalling layer.

A yet further aspect of an embodiment of the present invention contemplates a process for manufacturing a multi-layered protective glass system, comprising the steps of: cleaning surfaces of glass layers used in the multi-layered protective glass system, laying a first hybrid interlayer on a first glass layer or surface, laying a second layer of glass on top of the first hybrid interlayer, laying a second hybrid interlayer on a second glass layer or surface, laying a third layer of glass on top of the second hybrid interlayer, placing a thin layer of polymer film on the third layer of glass or surface, and laying a 23-mil thick PET film with Pressure Sensitive Adhesives (PSA) on the thin layer of polymer film.

In a yet further aspect of an embodiment of the present invention, the process for manufacturing a multi-layered protective glass system further comprises the step of trimming all the layers to the edge of the glass layers for a clean edge.

In a yet further aspect of an embodiment of the present invention, the process for manufacturing a multi-layered protective glass system further comprises the step of sealing edges of the layers using an insulated heat tape.

A yet further aspect of an embodiment of the present invention contemplates a process for manufacturing a multi-layered protective glass system, comprising the steps of: cleaning surfaces of a first glass layer used in the multi-layered protective glass system, laying a hybrid interlayer on the first glass layer, and laying a second glass layer on top of the first hybrid interlayer.

In a yet further aspect of an embodiment of the present invention, the process for manufacturing a multi-layered protective glass system further comprises steps of: trimming excess interlayer, sealing all edges of the glass layers and the hybrid interlayer together, laminating the glass layers and the hybrid interlayer, using a desired surface applied film application to apply pressure sensitive film on the first glass layer's surface, and trimming all layers of the first glass layer's edge.

A still further aspect of an embodiment of the present invention contemplates a process for manufacturing a multi-layered protective glass system, comprising the steps of: cleaning surfaces of a first glass layer used in the multi-layered protective glass system, laying a first hybrid interlayer on the first glass layer, laying a second glass layer on top of the first hybrid interlayer, laying a second hybrid interlayer on the first glass layer, and laying a third glass layer on top of the second hybrid interlayer.

In a still further aspect of an embodiment of the present invention, the manufacturing process further comprises the steps of: trimming excess interlayer, using an insulated heat tape to seal all edges of the glass layers and hybrid interlayers together, laminating the glass layers and hybrid interlayers, using a desired surface applied film application to apply pressure sensitive film on the first glass layer's surface, and trimming all layers of the first glass layer's edge.

In a still further aspect of an embodiment of the present invention, the cleaning of the glass layer surfaces may be done using isopropanol.

Each hybrid interlayer can be manipulated by changing the thicknesses and composition of each layer. The layers can possibly be rearranged depending on the applications. The process itself can only be done using an existing autoclave or a vacuum lamination oven. Aspects of embodiments of the present invention contemplate a protective glass system that can fit into most existing passenger vehicles without having to manipulate the door frames to fit the thickness of the window glass.

The objective of the glass is to prevent an attacker (who, using destructive objects) from gaining access into the vehicle or gaining access to the vehicle's occupants. The invention utilizes dissimilar materials combined for a thin armored composite window. The glass is also designed to be bullet resistant to certain bullets and attacks depending on the makeup of the overall invention. Unlike tempered glass, the window will still be held together even after being shot no matter what type of bullet, and the attacker will be unable to enter the vehicle, building, glass enclosed structure etc. for an extended amount of time.

The glass systems according to aspects of embodiments of the present invention are designed to slow an attacker's progress even after the systems have been shot or impacted. The glass systems according to aspects of embodiments of the present invention are the first of their kind to be used in passenger vehicles. The glass systems according to aspects of embodiments of the present invention show significant decrease in glass thickness and energy consumption for architectural needs. The added benefits of these glass systems include water resistance, enhanced acoustic protection, bomb blast resistance, cold weather resistance, and energy savings.

The advantages of the multi-layered protective glass system are significant when comparing it with common passenger vehicle glass. The invention can stop specific types of bullets depending on the construction of the glass and the film. It can also stop “smash and grab” or car hijackings from happening because the glass will not allow someone to breach the glass to go through the window. The invention will save lives by using a complex system of multiple layers of glass and polymers that create a thin and strong armored glass.

### BRIEF DESCRIPTION OF THE DRAWINGS

FIG. 1 illustrates a multi-layered protective glass system or Bullet Resistant Stack glass system according to an aspect of an embodiment of the present invention.

FIG. 2 illustrates a specialized multi-layered protective glass system according to an aspect of an embodiment of the present invention.

FIG. 3 illustrates a multi-layered protective glass system or Shooter Attack/Basic Automatic Stack glass system according to an aspect of an embodiment of the present invention.

FIG. 4 illustrates a multi-layered protective glass system or Hurricane and Impact Resistance Stack glass system according to an aspect of an embodiment of the present invention.

FIG. 5 illustrates a multi-layered protective glass system or All-In-One Bake Stack glass system according to an aspect of an embodiment of the present invention.

FIG. 6 illustrates a current glass system in use.

FIG. 7 illustrates a manufacturing process for manufacturing a Shooter Attack/Basic Automatic Stack Multi-layered Protective Glass System according to an aspect of an embodiment of the present invention.

FIG. 8 illustrates a manufacturing process for manufacturing a Bullet Resistant Stack Multi-layered Protective Glass System is shown according to an aspect of an embodiment of the present invention.

FIG. 9 illustrates a manufacturing process for manufacturing an All-In-One Stack Glass System is shown according to aspects of embodiments of the present invention.

### PARTS/ELEMENTS

100 Multi-layered protective glass system
102 First layer of glass
102A First side of first layer of glass
102B Second side of first layer of glass
Multilayer A First hybrid interlayer
104 First layer of ethylene vinyl acetate (EVA) of first hybrid interlayer
104A first side of first layer of ethylene vinyl acetate (EVA) of first hybrid interlayer
104B second side of first layer of ethylene vinyl acetate (EVA) of first hybrid interlayer
106 layer of modified polyethylene (MPE) of first hybrid interlayer
106A first side of the layer of modified polyethylene (MPE) of first hybrid interlayer
106B second side of the layer of modified polyethylene (MPE) of first hybrid interlayer
108 second layer of ethylene vinyl acetate (EVA) of first hybrid interlayer
108A first side of ethylene vinyl acetate (EVA) of first hybrid interlayer
108B second side of ethylene vinyl acetate (EVA) of first hybrid interlayer
110 Second layer of glass
110A first side of second layer of glass
110B second side of second layer of glass
Multilayer B Second hybrid interlayer
112 first layer of ethylene vinyl acetate (EVA) of second hybrid interlayer
112A first side of ethylene vinyl acetate (EVA) of second hybrid interlayer
112B second side of ethylene vinyl acetate (EVA) of second hybrid interlayer
114 layer of modified polyethylene (MPE) of second hybrid interlayer
114A first side of layer of modified polyethylene (MPE) of second hybrid interlayer
114B second side of layer of modified polyethylene (MPE) of second hybrid interlayer
116 2nd layer of ethylene vinyl acetate (EVA) of second hybrid interlayer
116A first side of ethylene vinyl acetate (EVA) of second hybrid interlayer
116B second side of ethylene vinyl acetate (EVA) of second hybrid interlayer
118 third layer of glass
118A first side of third layer of glass
118B second side of third layer of glass
Multilayer C anti-spalling layer
120 first layer of pressure sensitive adhesive
120A first side of first layer of pressure sensitive adhesive
120B second layer of pressure sensitive adhesive
122 first layer of polyethylene terephthalate (PET)
122A first side of first layer of polyethylene terephthalate (PET)
122B second side of first layer of polyethylene terephthalate (PET)
124 second layer of pressure sensitive adhesive
124A first side of second layer of pressure sensitive adhesive
124B second side of second layer of pressure sensitive adhesive
126 second layer of polyethylene terephthalate (PET)
126A first side of second layer of polyethylene terephthalate (PET)
126B second side of second layer of polyethylene terephthalate (PET)
128 third layer of pressure sensitive adhesive
128A first side of third layer of pressure sensitive adhesive
128B second side of third layer of pressure sensitive adhesive
130 third layer of polyethylene terephthalate (PET)
130A first side of third layer of polyethylene terephthalate (PET)
130B second side of third layer of polyethylene terephthalate (PET)
132 layer of self-healing surface coat (SHSC)
200 Specialized Multi-layered protective glass system
202 First layer of glass
202A First side of first layer of glass
202B Second side of first layer of glass
Multilayer A First hybrid interlayer
204 First layer of ethylene vinyl acetate (EVA) of first hybrid interlayer
204A first side of first layer of ethylene vinyl acetate (EVA) of first hybrid interlayer
204B second side of first layer of ethylene vinyl acetate (EVA) of first hybrid interlayer
206 layer of modified polyethylene (MPE) of first hybrid interlayer
206A first side of the layer of modified polyethylene (MPE) of first hybrid interlayer
206B second side of the layer of modified polyethylene (MPE) of first hybrid interlayer
208 second layer of ethylene vinyl acetate (EVA) of first hybrid interlayer
208A first side of ethylene vinyl acetate (EVA) of first hybrid interlayer
208B second side of ethylene vinyl acetate (EVA) of first hybrid interlayer
210 Second layer of glass
210A first side of second layer of glass
210B second side of second layer of glass
Multilayer B Second hybrid interlayer
212 first layer of ethylene vinyl acetate (EVA) of second hybrid interlayer
212A first side of ethylene vinyl acetate (EVA) of second hybrid interlayer
212B second side of ethylene vinyl acetate (EVA) of second hybrid interlayer
214 layer of modified polyethylene (MPE) of second hybrid interlayer
214A first side of layer of modified polyethylene (MPE) of second hybrid interlayer
214B second side of layer of modified polyethylene (MPE) of second hybrid interlayer
216 2nd layer of ethylene vinyl acetate (EVA) of second hybrid interlayer
216A first side of ethylene vinyl acetate (EVA) of second hybrid interlayer
216B second side of ethylene vinyl acetate (EVA) of second hybrid interlayer
218 third layer of glass
218A first side of third layer of glass
218B second side of third layer of glass
220 Separate layer of ethylene vinyl acetate (EVA)
220A first side of separate layer of ethylene vinyl acetate (EVA)
220B second side of separate layer of ethylene vinyl acetate (EVA)
Multilayer C anti-spalling layer
222 first layer of pressure sensitive adhesive
222A first side of first layer of pressure sensitive adhesive
222B second layer of pressure sensitive adhesive
224 first layer of polyethylene terephthalate (PET)
224A first side of first layer of polyethylene terephthalate (PET)
224B second side of first layer of polyethylene terephthalate (PET)
226 second layer of pressure sensitive adhesive
226A first side of second layer of pressure sensitive adhesive
226B second side of second layer of pressure sensitive adhesive
228 second layer of polyethylene terephthalate (PET)
228A first side of second layer of polyethylene terephthalate (PET)
228B second side of second layer of polyethylene terephthalate (PET)
230 third layer of pressure sensitive adhesive
230A first side of third layer of pressure sensitive adhesive
230B second side of third layer of pressure sensitive adhesive
232 third layer of polyethylene terephthalate (PET)
232A first side of third layer of polyethylene terephthalate (PET)
232B second side of third layer of polyethylene terephthalate (PET)
234 layer of self-healing surface coat (SHSC)
300 Shooter Attack/Basic Automatic Stack Multi-layered Protective Glass System
302 first layer of glass
302A first side of first layer of glass
302B second side of first layer of glass
Multilayer A Hybrid interlayer
304 first layer of layer of ethylene vinyl acetate (EVA)
304A first side of first layer of layer of ethylene vinyl acetate (EVA)
304B second side of first layer of layer of ethylene vinyl acetate (EVA)
306 layer of modified polyethylene (MPE)
306A first side of layer of modified polyethylene (MPE)
306B second side of layer of modified polyethylene (MPE)
308 second layer of layer of ethylene vinyl acetate (EVA)
308A first side of second layer of layer of ethylene vinyl acetate (EVA)
308B second side of second layer of layer of ethylene vinyl acetate (EVA)
310 second layer of glass
310A first side of second layer of glass
310B second side of second layer of glass
Multilayer B Anti-spalling layer
312 first layer of pressure sensitive adhesive (PSA)
312A first side of first layer of pressure sensitive adhesive (PSA)
312B second side of first layer of pressure sensitive adhesive (PSA)
314 first layer of polyethylene terephthalate (PET)
314A first side of first layer of polyethylene terephthalate (PET)
314B second side of first layer of polyethylene terephthalate (PET)
316 second layer of pressure sensitive adhesive (PSA)
316A first side of second layer of pressure sensitive adhesive (PSA)
316B second side of second layer of pressure sensitive adhesive (PSA)
318 second layer of polyethylene terephthalate (PET)
318A first side of second layer of polyethylene terephthalate (PET)
318B second side of second layer of polyethylene terephthalate (PET)
320 third layer of pressure sensitive adhesive (PSA)
320A first side of third layer of pressure sensitive adhesive (PSA)
320B second side of third layer of pressure sensitive adhesive (PSA)
322 third layer of polyethylene terephthalate (PET)
322A first side of third layer of polyethylene terephthalate (PET)
322B second side of third layer of polyethylene terephthalate (PET)
324 layer of self-healing surface coat (SHSC)
400 Hurricane and Impact Resistance Stack Multi-layered protective glass system
402 first layer of glass
402A first side of first layer of glass
402B second side of first layer of glass
Multilayer A Hybrid interlayer
404 first layer of layer of ethylene vinyl acetate (EVA)
404A first side of first layer of layer of ethylene vinyl acetate (EVA)
404B second side of first layer of layer of ethylene vinyl acetate (EVA)
406 layer of modified polyethylene (MPE)
406A first side of layer of modified polyethylene (MPE)
406B second side of layer of modified polyethylene (MPE)
408 second layer of ethylene vinyl acetate (EVA)
408A first side of second layer of layer of ethylene vinyl acetate (EVA)
408B second side of second layer of layer of ethylene vinyl acetate (EVA)
410 second layer of glass
410A first side of second layer of glass
410B second side of second layer of glass
Multilayer B Anti-spalling layer
412 first layer of pressure sensitive adhesive (PSA)
412A first side of first layer of pressure sensitive adhesive (PSA)
412B second side of first layer of pressure sensitive adhesive (PSA)
414 first layer of polyethylene terephthalate (PET)
414A first side of first layer of polyethylene terephthalate (PET)
414B second side of first layer of polyethylene terephthalate (PET)
416 second layer of pressure sensitive adhesive (PSA)
416A first side of second layer of pressure sensitive adhesive (PSA)
416B second side of second layer of pressure sensitive adhesive (PSA)
418 second layer of polyethylene terephthalate (PET)
418A first side of second layer of polyethylene terephthalate (PET)
418B second side of second layer of polyethylene terephthalate (PET)
420 third layer of pressure sensitive adhesive (PSA)
420A first side of third layer of pressure sensitive adhesive (PSA)
420B second side of third layer of pressure sensitive adhesive (PSA)
422 third layer of polyethylene terephthalate (PET)
422A first side of third layer of polyethylene terephthalate (PET)
422B second side of third layer of polyethylene terephthalate (PET)
424 layer of self-healing surface coat (SHSC)
500 All-In-One Bake Stack Multi-layered protective glass system
502 first layer of glass
502A first side of first layer of glass
502B second side of first layer of glass
Multilayer A Hybrid interlayer
510 second layer of glass
510A first side of second layer of glass
510B second side of second layer of glass
512 Separate layer of ethylene vinyl acetate (EVA)
Multilayer B Anti-spalling layer
514 first layer of polyethylene terephthalate (PET)
514A first side of first layer of polyethylene terephthalate (PET)
514B second side of first layer of polyethylene terephthalate (PET)
516 second layer of pressure sensitive adhesive (PS A)
516A first side of second layer of pressure sensitive adhesive (PSA)
516B second side of second layer of pressure sensitive adhesive (PSA)
518 second layer of polyethylene terephthalate (PET)
518A first side of second layer of polyethylene terephthalate (PET)
518B second side of second layer of polyethylene terephthalate (PET)
520 third layer of pressure sensitive adhesive (PSA)
520A first side of third layer of pressure sensitive adhesive (PSA)
520B second side of third layer of pressure sensitive adhesive (PSA)
522 third layer of polyethylene terephthalate (PET)
522A first side of third layer of polyethylene terephthalate (PET)
522B second side of third layer of polyethylene terephthalate (PET)
524 layer of self-healing surface coat (SHSC)

### DETAILED DESCRIPTION

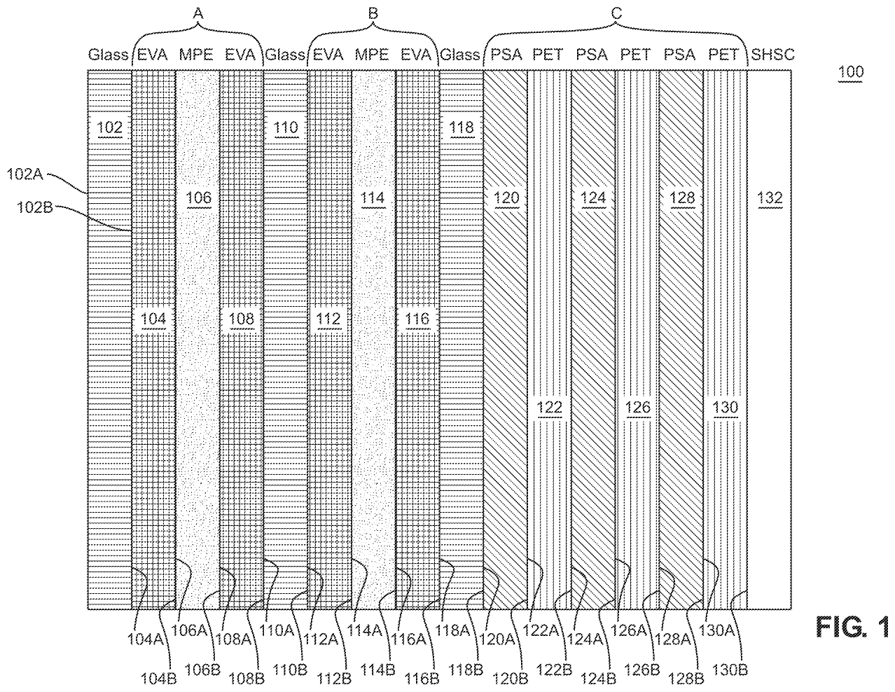

Referring now to FIG. 1, a multi-layered protective glass system or Bullet Resistant Stack glass system 100 is shown according to aspects of embodiments of the present invention. Multi-layered protective glass system 100 may include first layer of glass 102 which may have first and second sides 102A, 102B. Glass system 100 may also include first hybrid interlayer A, which may include first and second layers of ethylene vinyl acetate (EVA), 104, 108, and a layer of modified polyethylene (MPE) 106. Each of these layers may include first and second sides 104A and 104B (for first ethylene vinyl acetate (EVA) layer); first and second sides 106A and 106B (for modified polyethylene (MPE) layer 106); and first and second sides 108A, 108B (for second ethylene vinyl acetate (EVA) layer 108). In an aspect of an embodiment of the present invention, modified polyethylene (MPE) layer 106 may be interposed between ethylene vinyl acetate (EVA) layers 104 and 108. In an aspect of an embodiment of the present invention, second side 102B of first layer of glass 102 may be superimposed on the first side of the first hybrid interlayer A, where the first side of first hybrid interlayer A is formed by first side 104A of ethylene vinyl acetate layer 104.

Glass system 100 may also include second layer of glass, 110 comprising of first and second sides (110A and 110B), where the second side of the first hybrid interlayer A, (as formed by second side 108B of second ethylene vinyl acetate (EVA) layer 108) may be superimposed on the first side 110A of second layer of glass 110.

Glass system 100 may also include second hybrid interlayer B, which may include first and second layers of ethylene vinyl acetate (EVA), 112, 116, and modified polyethylene (MPE) layer 114. Each of these layers may include first and second sides 112A and 112B (for first ethylene vinyl acetate (EVA) layer 112); first and second sides 114A and 114B (for modified polyethylene (MPE) layer 114); and first and second sides 116A, 116B (for second ethylene vinyl acetate (EVA) layer 116). In an aspect of an embodiment of the present invention, modified polyethylene (MPE) layer 114 may be interposed between ethylene vinyl acetate (EVA) layers 112 and 116.

In an aspect of an embodiment of the present invention, second side 110B of second layer of glass 110 may be superimposed on first side of second hybrid interlayer B, where the first side is formed by first side 112A of ethylene vinyl acetate (EVA) layer 112 of second hybrid interlayer B.

Second hybrid interlayer B may have a second side formed by second side 116B of second ethylene vinyl acetate (EVA) layer 116. This side may be superimposed on first side 118A of third layer of glass 118. Third glass layer 118 may include second side 118B which, in an aspect of an embodiment of the present invention, may be superimposed on an anti-spalling layer, C. Anti-spalling layer, C may include first, second and third pressure sensitive adhesive layers 120, 124 and 128 and first, second and third polyethylene terephthalate (PET) layers 122, 126 nd 130 where each individual layer 120, 122, 124, 126, 128 and 130 may each respectively include first and second sides.

In an aspect of an embodiment of the present invention, second side 118B of glass layer 118 may be superimposed on a first side of anti-spalling layer, C where the first side of anti-spalling layer C may be formed by first side 120A of first pressure sensitive adhesive layer 120.

In an aspect of an embodiment of the present invention, second side 120B of first pressure sensitive adhesive (PSA) layer 120 may be superimposed on first side 122A of first polyethylene terephthalate (PET) layer 122. First polyethylene terephthalate (PET) layer 122, by way of second side 122B of first polyethylene terephthalate (PET) layer 122, may be superimposed on second pressure sensitive adhesive (PSA) layer 124. Second pressure sensitive adhesive (PSA) layer 124, by way of second side 124B of second pressure sensitive adhesive (PSA) layer 124 may be superimposed on the first side 126A of second polyethylene terephthalate (PET) layer 126. Second polyethylene terephthalate (PET) layer 126, by way of second side 126B of second polyethylene terephthalate (PET) layer 126, may be superimposed on the first side 128A of third pressure sensitive adhesive layer 128. Third pressure sensitive adhesive layer 128, may, by way of second side 128B of third pressure sensitive adhesive (PSA) layer 128, may be superimposed on the first side 130A of third polyethylene terephthalate (PET) layer 130, which in turn may, by way of second side 130B of third polyethylene terephthalate (PET) layer 130, be may be superimposed on self-healing surface coat 132.

In a non-limiting aspect of an embodiment of the present invention, the individual thicknesses of any one or more of glass layers 102, 110, 118 may be between 2.2 mm to 6.5 mm thick. In an aspect of an embodiment of the present invention, hybrid interlayers A and B may also have various interchangeable thicknesses ranging from 0.2 mm to 1.0 mm for different applications and specifications. An exemplary preferred makeup is an overall thickness of 11 mm thick—which is currently the thinnest material to stop a 9 mm bullet. Other variations utilize different compositions of glass on the outside like using heat or chemically tempered glass to decrease rock chipping or stopping other types of bullets. To date, automobile companies typically have not used such a robust layered system that is specifically invented to protect people from bullets and blunt attacks in a vehicle. Because of the several layers of material, thermal insulation will be significantly higher than any single pane, or three-layer glass laminate.

An exemplary, non-limiting aspect of an embodiment of the present invention contemplates a glass system 100 as shown in FIG. 1 was tested with layers having the following exemplary, and non-limiting compositions, configurations, and thicknesses:

Layer 1 (102): 5.0 mm=Borosilicate Glass or other Annealed Glass (up to 10 mm thick)
Layer 2 (104): 0.2 mm=Hybrid Interlayer Pt 1—Ethylene Vinyl Acetate EVA
Layer 3 (106): 0.4 mm=Hybrid Interlayer Pt 2—Modified Polyethylene MPE
Layer 4 (108): 0.2 mm=Hybrid Interlayer Pt 3 Ethylene Vinyl Acetate EVA
Layer 5 (110): 2.0 mm=Borosilicate Glass or other Annealed Glass (up to 10 mm thick)
Layer 6 (112): 0.2 mm=Hybrid Interlayer Pt 1—Ethylene Vinyl Acetate EVA (various thicknesses)
Layer 7 (114): 0.4 mm=Hybrid Interlayer Pt 2—Modified Polyethylene MPE (various thicknesses)
Layer 8 (116): 0.2 mm=Hybrid Interlayer Pt 3—Ethylene Vinyl Acetate EVA (various thicknesses)
Layer 9 (118): 2.0 mm=Borosilicate Glass or other Annealed Glass (up to 10 mm thick)
Layer 10 (120): Pressure Sensitive Adhesive
Layer 11 (122): 7 mil Polyethylene Terephthalate PET
Layer 12 (124): Pressure Sensitive Adhesive
Layer 13 (126): 7 mil Polyethylene Terephthalate PET
Layer 14 (128): Pressure Sensitive Adhesive
Layer 15 (130): 7 mil Polyethylene Terephthalate PET
Layer 16 (132): Self-Healing/Anti-Scratch Surface Hard Coat

Operation

Layer 1 (i.e., first glass layer 102) would break up the first bullet in a shooting situation or be the barrier to the first several hits of an object like a bat or wrench. The glass can be customized based on optical, thermal, and mechanical specifications. Layers 2-4 (i.e., first hybrid interlayer, A) is a hybrid interlayer specifically designed to absorb and repel energy when it is attacked. The high Young's modulus of the interlayer is essential to slow the bullet's mass as it dissipates energy against a blunt object's attack.

Layer 5 (i.e., second glass layer 110) for ballistic purposes breaks up the bullet even more, thus slowing it down, and causing the bullet to fragment even more. Layers 6-8 which is second hybrid interlayer, B is used to further slowdown and catch the bullet fragments. Layer 9 (i.e., third glass layer 118) is used to crack and catch the last of the bullet fragments. Layers 10-15 (i.e., anti-spalling layer C) is part of a three-layer polyethylene terephthalate film combined with a polymeric pressure sensitive adhesive. This acts as an anti-spalling system that is meant to keep the glass intact in an attack while not harming the occupants on the other side of the glass. The film is also bomb blast rated (depending on the framing) and used as the last line of defense to keep the glass from blowing inwards after a bullet is shot and/or a bat or other blunt instruments being swung at the window multiple times. Layer 16 (i.e., self-healing surface coat layer 132) is a cosmetic layer designed to be a durable scratch resistant coating and can be customized to be self-healing as well.

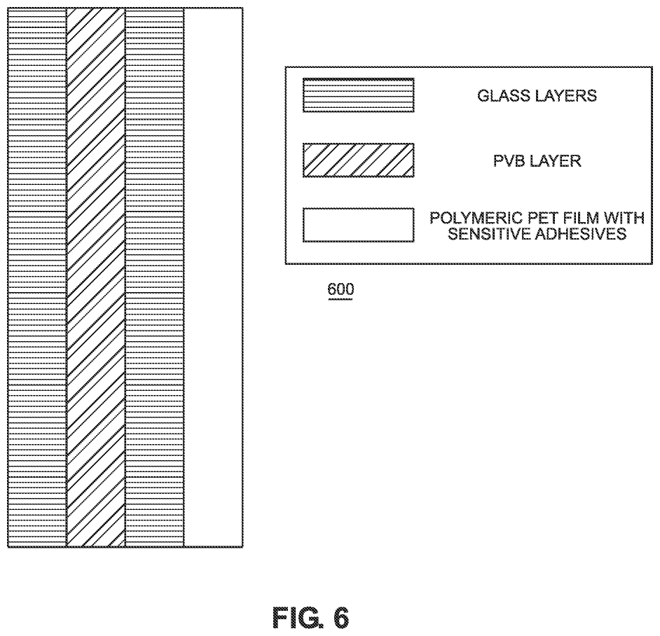

The glass layers used in this aspect of an embodiment of the present invention can be customized for various optical, thermal, and mechanical properties for different applications. Because the system has multiple layers of glass and polymeric materials, the ultra-violet light absorption will be 99.9%, and have a much higher thermal insulation compared to the existing system shown in FIG. 6. The acoustics for sound should theoretically be significantly better than a single layer tempered or three-layer laminated glass as well.

Testing & Test Results

A sampling of tests and test results for the above non-limiting aspects of embodiments of glass system 100 of the present invention were conducted and are reflected in the accompanying testing results.

### Materials

### Test Piece Features

Frame: Wood with VHB Tape
Glazing: Hybrid ¼″ Laminated glass and 23 MIL Shooter Attack Film

### Gun Type: AR-15

### Bullet Type: Remington 0.223 Bullets

### Climate

### Range Temp.: 15 DEGREES FAHRENHEIT

### Glass Surface Temperature: 22 DEGREES FAHRENHEIT

### Procedure

### FTD-SA Standard

The glass was placed in the wooden frames with VHB tape on both sides of the frame to anchor the glass. The film side of the laminated glass was considered the “safe” side The frame was anchored with three screws on each side to keep the glass and wood together. The glass was then shot in the predetermined pattern in accordance with the FTD-SA testing standard.

A failure is either when the glass and film is punctured through with the head of the ram.

TABLE 1
TEST RESULTS DATA

| CLASS | FT/LBS | HIT # | PASS/FAIL |
|---|---|---|---|
| 1 | 50 | 1 | PASS |
| 1 | 50 | 2 | PASS |
| 2 | 75 | 1 | PASS |
| 2 | 75 | 2 | PASS |
| 3 | 100 | 1 | PASS |
| 3 | 100 | 2 | PASS |
| 4 | 125 | 1 | PASS |
| 4 | 125 | 2 | PASS |
| 5 | 150 | 1 | PASS |
| 5 | 150 | 2 | PASS |
| 6 | 175 | 1 | PASS |
| 6 | 175 | 2 | PASS |
| 7 | 200 | 1 | PASS |
| 7 | 200 | 2 | PASS |
| 8 | 225 | 1 | PASS |
| 8 | 225 | 2 | PASS |
| 9 | 250 | 1 | PASS |
| 9 | 250 | 2 | FAIL |

### Summary

### Testing was Completed on Following:

### FRAME: WOOD WITH VHB TAPE

### GLAZING: HYBRID ¼″ LAMINATED GLASS AND 23 MIL SHOOTER ATTACK FILM

### THE RESULTS SHOW THAT THE GLASS FAILED ON THE SECOND HIT OF CLASS 9 AT 250 FT/LBS OF ENERGY. ¼″ LAMINATE PASSED CLASS 8 UTILIZING THE HYBRID INTERLAYER IN A COLD CLIMATE.

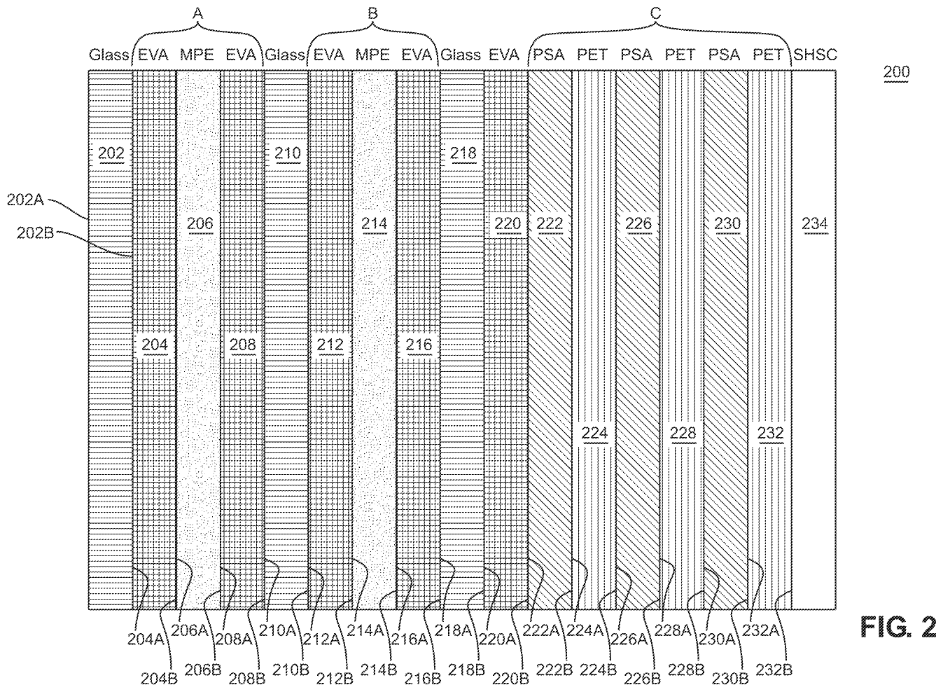

Referring now to FIG. 2, a specialized multi-layered protective glass system 200 is shown according to aspects of embodiments of the present invention. Multi-layered protective glass system 200 may include first layer of glass 202 which may have first and second sides 202A, 202B. Glass system 200 may also include first hybrid interlayer A, which may include first and second layers of ethylene vinyl acetate (EVA), 204, 208, and a layer of modified polyethylene (MPE) 206. Each of these layers may include first and second sides 204A and 204B (for first ethylene vinyl acetate (EVA) layer); first and second sides 206A and 206B (for modified polyethylene (MPE) layer 206); and first and second sides 208A, 208B (for second ethylene vinyl acetate (EVA) layer 208). In an aspect of an embodiment of the present invention, modified polyethylene (MPE) layer 206 may be interposed between ethylene vinyl acetate (EVA) layers 204 and 208. In an aspect of an embodiment of the present invention, second side 202B of first layer of glass 202 may be superimposed on the first side of the first hybrid interlayer A, where the first side of first hybrid interlayer A is formed by first side 204A of ethylene vinyl acetate layer 204.

Glass system 200 may also include second layer of glass, 210 comprising of first and second sides (210A and 210B), where the second side of the first hybrid interlayer A, (as formed by second side 208B of second ethylene vinyl acetate (EVA) layer 208) may be superimposed on the first side 210A of second layer of glass 210.

Glass system 200 may also include second hybrid interlayer B, which may include first and second layers of ethylene vinyl acetate (EVA), 212, 216, and modified polyethylene (MPE) layer 214. Each of these layers may include first and second sides 212A and 212B (for first ethylene vinyl acetate (EVA) layer 212); first and second sides 214A and 214B (for modified polyethylene (MPE) layer 214); and first and second sides 216A, 216B (for second ethylene vinyl acetate (EVA) layer 216). In an aspect of an embodiment of the present invention, modified polyethylene (MPE) layer 214 may be interposed between ethylene vinyl acetate (EVA) layers 212 and 216.

In an aspect of an embodiment of the present invention, second side 210B of second layer of glass 210 may be superimposed on first side of second hybrid interlayer B, where the first side is formed by first side 212A of ethylene vinyl acetate (EVA) layer 212.

Second hybrid interlayer B may have a second side formed by second side 216B of second ethylene vinyl acetate (EVA) layer 216. This side may be superimposed on first side 218A of third layer of glass 218. Third glass layer 218 may include second side 218B which, in an aspect of an embodiment of the present invention, may be superimposed on an anti-spalling layer, C. Anti-spalling layer, C may include first, second and third pressure sensitive adhesive layers 222, 226 and 230 and first, second and third polyethylene terephthalate (PET) layers 224, 228 and 232.

In an aspect of an embodiment of the present invention, specialized multi-layered protective glass system 200 may further include ethylene vinyl acetate (EVA) layer 220, which, in an aspect of an embodiment of the present invention, may be interposed between the 3rd glass layer 218 and anti-spalling layer C.

In an aspect of an embodiment of the present invention, first side 220A of ethylene vinyl acetate (EVA) layer 220 may be superimposed on second side 218B of third glass layer while second side 220B of ethylene vinyl acetate (EVA) layer 220 may be superimposed on first side 222A of first pressure sensitive adhesive layer 222. In an aspect of an embodiment of the present invention, second side 218B of glass layer 218 may be superimposed on a first side of anti-spalling layer, C where the first side of anti-spalling layer C may be formed by first side 220A of ethylene vinyl acetate (EVA) layer 220.

Second side 220B of ethylene vinyl acetate (EVA) layer 220 may be superimposed on first side 222A of first pressure sensitive adhesive layer 222. In an aspect of an embodiment of the present invention, second side 222B of first pressure sensitive adhesive (PSA) layer 222 may be superimposed on first side 224A of first polyethylene terephthalate (PET) layer 224, which in turn, by way of second side 224B of first polyethylene terephthalate (PET) layer 224 may be superimposed on first side 226B of second pressure sensitive adhesive (PSA) layer 226. In an aspect of an embodiment of the present invention, second side 226B of second pressure sensitive adhesive (PSA) layer 226 may be superimposed on first side 228A of second polyethylene terephthalate (PET) layer 228, which in turn, by way of second side 228B of second polyethylene terephthalate (PET) layer 228, may be superimposed on first side 230A of third pressure sensitive adhesive layer 230. Third pressure sensitive adhesive (PSA) layer 230, by way of second side 230B of third pressure sensitive adhesive (PSA) layer 230, may be superimposed on first side 232A of third polyethylene terephthalate (PET) layer 232.

In an aspect of an embodiment of the present invention, glass system 200 may further comprise of self-healing surface coat (SHSC) layer 234, which, in an aspect of an embodiment of the present invention, may superimposed on the second side of anti-spalling layer as formed by second side 232B of third polyethylene terephthalate (PET) layer 232.

In an aspect of an embodiment of the present invention, any one or more of the layers of glass 102, 110, 118, 202, 210, 218 may be any one of: borosilicate glass, annealed glass, heat strengthened glass, tempered glass.

An exemplary, non-limiting aspect of an embodiment of the present invention contemplates a glass system 200 as shown in FIG. 2 was tested with layers having the following exemplary, and non-limiting compositions, configurations, and thicknesses:
1^{st} Glass Layer (202): 5.0 mm=Borosilicate Glass
1^{st} Hybrid Interlayer A (comprising of the following sub-layers):
   Sub-Layer 1 (204): 0.2 mm=Ethylene Vinyl Acetate EVA
   Sub-Layer 2 (206): 0.4 mm=Modified Polyethylene MPE
   Sub-Layer 3 (208): 0.2 mm=Ethylene Vinyl Acetate EVA
2nd Glass Layer (210): 2.0 mm=Borosilicate Glass
2^{nd} Hybrid Interlayer B (comprising of the following sub-layers):
   Sub-Layer 1 (212): 0.2 mm=Ethylene Vinyl Acetate EVA (various thicknesses)
   Sub-Layer 2 (214): 0.4 mm=Modified Polyethylene MPE (various thicknesses)
   Sub-Layer 3 (216): 0.2 mm=Ethylene Vinyl Acetate EVA (various thicknesses) 3rd Glass Layer (218): 2.0 mm=Borosilicate Glass
Single Ethylene Vinyl Acetate (EVA) Layer (220): 0.2 mm=Ethylene Vinyl Acetate
Anti-Spalling Layer C (comprising of the following sub-layers):
   Sub-Layer 1 (224): 7 mil Polyethylene Terephthalate PET
   Sub-Layer 2 (226): Pressure Sensitive Adhesive
   Sub-Layer 3 (228): 7 mil Polyethylene Terephthalate PET
   Sub-Layer 4 (230): Pressure Sensitive Adhesive
   Sub-Layer 5 (232): 7 mil Polyethylene Terephthalate PET
Separate Self-Healing Surface Hard Coat Layer (234)

Every layer serves a purpose to slow an attacker. The hybrid interlayers are connected because they are specifically designed to absorb and dissipate energy of a bullet to slow down the bullet mass as it passes through the layers of the stackable polymer interlayer. Young's Modulus is essential to any ballistic interlayer because the stiffness of the invention interlayer will not delaminate like a traditional polyvinyl butyral (PVB) interlayer. Glass in cars have never used this technology simply because they are content with using a single glass layer or a single lamination glass because of the associated low cost. A multi-laminated system utilizing the stackable interlayer dissipates energy at a significantly higher rate than a single pane glass, or a PVB interlayer which is currently being used in windshields. Delamination also occurs at a significantly lower amount than any interlayer available on the market because of the adhesion properties for the glass and EVA interface. When the interlayer is in the melting process, cross-linking¹ occurs throughout 98.9% of the 3-layer system. PVB has a cross-linking rate of about 89% with a much higher price tag. The added interfaces of the interlayers allow a much higher amount of energy to be dissipated compared to the traditional single layer systems. ¹ Crosslinking is when covalent bonds are formed in short sequences of chemical bonds of 2 different polymer chains. The higher the cross-link, the more strong and rigid the material. The higher the cross-link percentage the stronger the material is which is actually good for ballistics.

The 1st Glass Layer (i.e., glass layer 202) would break up the first bullet in a shooting situation or be the barrier to the first several hits of an object like a bat or wrench. The glass can be customized based on optical, thermal, and mechanical specifications. The 1st Hybrid Interlayer A is a hybrid interlayer specifically designed to absorb and repel energy when the multi-layered protective glass system 200 is attacked. The high Young's modulus of this interlayer is essential to slow the bullet's mass as it dissipates energy against a blunt object's attack. The 2nd Glass layer (i.e., glass layer 210), for ballistic purposes, breaks up the bullet even more, thus slowing it down, and causing the bullet to fragment even more. The 2nd Hybrid Interlayer B is used to further slowdown and catch the bullet fragments. The 3rd Glass layer (glass layer 218) is used to crack and catch the last of the bullet fragments. The single EVA layer (layer 220) acts as a polymeric adhesive layer for the anti-spalling film, which is not typically used by automakers. Anti-Spalling layer C is meant to keep the glass intact in an attack while also protecting the occupants on the other side of the glass. The film is also bomb blast rated and used as the last line of defense to keep the glass from blowing inwards after a bullet is shot or after a bat has been swung at the window multiple times. Self-Healing Surface Coat (SHSC) layer 234 is a cosmetic layer designed to be a durable scratch resistant coating and can be customized to be self-healing as well. The layers of glass used in aspects of embodiments of the present invention can be customized for various optical, thermal, and mechanical properties for different applications. Because the system has multiple layers of glass and polymeric materials, the ultra-violet light absorption will be 99.9%, and have a much higher thermal insulation compared to the contemporary glass system shown in FIG. 6. The acoustics for sound should theoretically be significantly better than a single layer tempered or three-layer laminated glass as well.

In an aspect of an embodiment of the present invention, the two layers of EVA sandwiching the MPE layer may be combined together using a temporary polymer adhesive, which, when the interlayer is used to laminate glass, would melt into the EVA layer with a similar crystal structure. As a result, the cross linking will still be high.

One exemplary, non-limiting aspect of an embodiment of the present invention is an 11 mm thick makeup which is currently the thinnest configuration capable of stopping a 9 mm bullet. Other embodiments contemplate utilizing different compositions of glass on the outside like using heat or chemically tempered glass to decrease rock chipping. Automobile companies have never used such a robust layered system that is specifically invented to protect people from bullets and blunt attacks in a vehicle. Because of the several layers of material, thermal insulation will be significantly higher than any single pane, or three-layer glass laminate. The multiple layers of the contemplated multi-layered protective glass system present a better system in a shooter attack because each interface between the materials allows increased energy dissipation of a blunt object or a bullet passing through, thus leaving the glass intact.

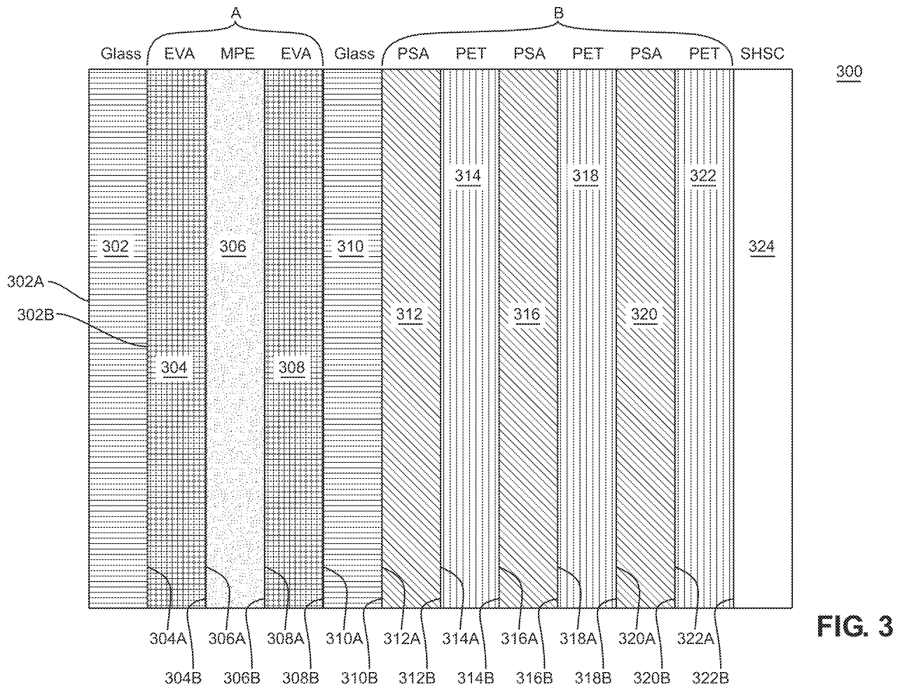

Referring now to FIG. 3, a multi-layered protective glass system or Shooter Attack/Basic Automatic Stack glass system 300 is shown according to aspects of an embodiment of the present invention. Multi-layered protective glass system 300 may include first layer of glass 302 which may have first and second sides 302A, 302B. Glass system 300 may also include first hybrid interlayer A, which may include first and second layers of ethylene vinyl acetate (EVA), 304, 308, and a layer of modified polyethylene (MPE) 306. Each of these layers may include first and second sides 304A and 304B (for first ethylene vinyl acetate (EVA) layer 304); first and second sides 306A and 306B (for modified polyethylene (MPE) layer 306); and first and second sides 308A, 308B (for second ethylene vinyl acetate (EVA) layer 308). In an aspect of an embodiment of the present invention, modified polyethylene (MPE) layer 306 may be interposed between ethylene vinyl acetate (EVA) layers 304 and 308. In an aspect of an embodiment of the present invention, second side 302B of first layer of glass 302 may be superimposed on the first side of the first hybrid interlayer A, where the first side of first hybrid interlayer A is formed by first side 304A of ethylene vinyl acetate layer 304.

Glass system 300 may also include second layer of glass, 310 comprising of first and second sides (310A and 310B), where the second side of the first hybrid interlayer A, (as formed by second side 308B of second ethylene vinyl acetate (EVA) layer 308) may be superimposed on the first side 310A of second layer of glass 310.

Anti-spalling layer, B of glass system 300 may include first, second and third pressure sensitive adhesive layers 312, 316 and 320 and first, second and third polyethylene terephthalate (PET) layers 314, 318 and 322.

In an aspect of an embodiment of the present invention, second side 310B of glass layer 310 may be superimposed on a first side of anti-spalling layer, B of glass system 300 where the first side of anti-spalling layer B may be formed by first side 312A of first pressure sensitive adhesive layer 312.

In an aspect of an embodiment of the present invention, second side 312B of first pressure sensitive adhesive (PSA) layer 312 may be superimposed on first side 314A of first polyethylene terephthalate (PET) layer 314. First polyethylene terephthalate (PET) layer 314, by way of second side 314B of first polyethylene terephthalate (PET) layer 314, may be superimposed on first side 316A of second pressure sensitive adhesive (PSA) layer 316, which in turn, by way of its second side 316B, may be superimposed on first side 318A of second polyethylene terephthalate (PET) layer 318. Second polyethylene terephthalate (PET) layer 318, by way of its second side 318B, may be superimposed on first side 320A of third pressure sensitive adhesive layer 320, which in turn, by way of second side 320B of third pressure sensitive adhesive (PSA) layer 320, may be superimposed on first side 322A of third polyethylene terephthalate (PET) layer 322.

In an aspect of an embodiment of the present invention, glass system 300 may further comprise of self-healing surface coat (SHSC) layer 324, which, in an aspect of an embodiment of the present invention, may superimposed on the second side of anti-spalling layer B of glass system 300 as formed by second side 322B of third polyethylene terephthalate (PET) layer 322.

In an aspect of an embodiment of the present invention, any one or more of glass layers 302, 310 may be any one of: borosilicate glass, or annealed glass.

An exemplary, non-limiting aspect of an embodiment of the present invention contemplates a glass system 300 as shown in FIG. 3 was tested with layers having the following exemplary, and non-limiting compositions, configurations, and thicknesses:
Layer 1 (302): 2.2 mm=Annealed Glass (up to 6 mm thick)
Layer 2 (304): 0.2 mm=Hybrid Interlayer Pt 1—Ethylene Vinyl Acetate EVA (up to 1 mm thick)
Layer 3 (306): 0.2 mm=Hybrid Interlayer Pt 2—Modified Polyethylene MPE (up to 1 mm thick)
Layer 4 (308): 0.2 mm=Hybrid Interlayer Pt 3—Ethylene Vinyl Acetate EVA (up to 1 mm thick)
Layer 5 (310): 2.0 mm=Annealed Glass (up to 6 mm thick)
Layer 6 (312): Pressure Sensitive Adhesive
Layer 7 (314): 7 mil Polyethylene Terephthalate PET (or other polymers)
Layer 8 (316): Pressure Sensitive Adhesive
Layer 9 (318): 7 mil Polyethylene Terephthalate PET (or other polymers)
Layer 10 (320): Pressure Sensitive Adhesive
Layer 11 (322): 7 mil Polyethylene Terephthalate PET (or other polymers)
Layer 12 (324): Self-Healing/Anti-Scratch Surface Hard Coat

Operation

Layer 1 (first glass layer 302) would break up the first bullet depending on the caliber in a shooting situation or be the barrier to the first several hits of an object like a bat or wrench. The glass can be customized based on optical, thermal, and mechanical specifications. The primary purpose of the two-layer stack is to allow the bullet to pass through but remain intact after blunt impacts. Layers 2-4 is hybrid interlayer A which is specifically designed to absorb and repel energy when it is attacked. The high Young's modulus of the interlayer is essential to slow the bullet's mass as it dissipates energy against a blunt object's attack. Layer 5 (second glass layer 310) is the second layer of glass that keeps the laminated structure intact while letting the bullet pass through. Layers 6-11 is part of a three-layer polyethylene terephthalate film combined with a polymeric pressure sensitive adhesive. This acts as an anti-spalling system that is meant to keep the glass intact in an attack and not harming the occupants on the other side of the glass. The film is also bomb blast rated (depending on the framing) and used as the last line of defense to keep the glass from blowing inwards after a bullet is shot and a bat or other blunt instruments being swung at the window multiple times. Layer 12 is a cosmetic layer designed to be a durable scratch resistant coating and can be customized to be self-healing as well. The glasses used in the invention can be customized for various optical, thermal, and mechanical properties for different applications. Because the system has multiple layers of glass and polymeric materials, the ultra-violet light absorption will be 99.9% due to the Hybrid interlayer, and have a much higher thermal insulation compared to Exhibit E. The acoustics for sound should theoretically be significantly better than a single layer tempered or three-layer laminated glass as well.

Testing & Test Results

A sampling of tests and test results for the above non-limiting aspects of embodiments of glass system 300 of the present invention were conducted and are reflected in the accompanying testing results.

Test #1:

### Materials

### Test Piece Features

Frame: Wood with VHB Tape
Glazing: Hybrid ¼″ Laminated glass and 23 MIL Shooter Attack Film

### Gun Type: AR-15

### Bullet Type: Remington 0.223 Bullets

### Climate

### Range Temp.: 70 DEGREES FAHRENHEIT

### Glass Surface Temperature: 70 DEGREES FAHRENHEIT

### Procedure

### FTD-SA Standard

The glass was placed in the wooden frames with VHB tape on both sides of the frame to anchor the glass. The film side of the laminated glass was considered the “safe” side. The frame was anchored with three screws on each side to keep the glass and wood together. The glass was then shot in the predetermined pattern in accordance with the FTD-SA testing standard.

A failure is either when the glass and film is punctured through with the head of the ram.

TABLE 2
TEST RESULTS DATA

| CLASS | FT/LBS | HIT # | PASS/FAIL |
|---|---|---|---|
| 1 | 50 | 1 | PASS |
| 1 | 50 | 2 | PASS |
| 2 | 75 | 1 | PASS |
| 2 | 75 | 2 | PASS |
| 3 | 100 | 1 | PASS |
| 3 | 100 | 2 | PASS |
| 4 | 125 | 1 | PASS |
| 4 | 125 | 2 | PASS |
| 5 | 150 | 1 | PASS |
| 5 | 150 | 2 | PASS |
| 6 | 175 | 1 | PASS |
| 6 | 175 | 2 | PASS |
| 7 | 200 | 1 | PASS |
| 7 | 200 | 2 | PASS |
| 8 | 225 | 1 | PASS |
| 8 | 225 | 2 | PASS |
| 9 | 250 | 1 | PASS |
| 9 | 250 | 2 | FAIL |

### Summary

### Testing was Completed on Following:

### FRAME: WOOD WITH VHB TAPE

### GLAZING: HYBRID ¼″ LAMINATED GLASS AND 23 MIL SHOOTER ATTACK FILM

### THE RESULTS SHOW THAT THE GLASS FAILED ON THE SECOND HIT OF CLASS 9 AT 250 FT/LBS OF ENERGY. ¼″ LAMINATE PASSED CLASS 8 UTILIZING THE HYBRID INTERLAYER.

### Test 2

### Materials

### Test Piece Features

Frame: Wood with VHB Tape
Glazing: Hybrid ¼″ Laminated glass and 23 MIL Shooter Attack Film

### Gun Type: AR-15

### Bullet Type: Remington 0.223 Bullets

### Climate

### Range Temp.: 15 DEGREES FAHRENHEIT

### Glass Surface Temperature: 22 DEGREES FAHRENHEIT

### Procedure

### FTD-SA Standard

The glass was placed in the wooden frames with VHB tape on both sides of the frame to anchor the glass. The film side of the laminated glass was considered the “safe” side. The frame was anchored with three screws on each side to keep the glass and wood together. The glass was then shot in the predetermined pattern in accordance with the FTD-SA testing standard.

A failure is either when the glass and film is punctured through with the head of the ram.

TABLE 3
TEST RESULTS DATA

| CLASS | FT/LBS | HIT # | PASS/FAIL |
|---|---|---|---|
| 1 | 50 | 1 | PASS |
| 1 | 50 | 2 | PASS |
| 2 | 75 | 1 | PASS |
| 2 | 75 | 2 | PASS |
| 3 | 100 | 1 | PASS |
| 3 | 100 | 2 | PASS |
| 4 | 125 | 1 | PASS |
| 4 | 125 | 2 | PASS |
| 5 | 150 | 1 | PASS |
| 5 | 150 | 2 | PASS |
| 6 | 175 | 1 | PASS |
| 6 | 175 | 2 | PASS |
| 7 | 200 | 1 | PASS |
| 7 | 200 | 2 | PASS |
| 8 | 225 | 1 | PASS |
| 8 | 225 | 2 | PASS |
| 9 | 250 | 1 | PASS |
| 9 | 250 | 2 | FAIL |

The purpose of the glass was to allow a bullet to pass through the glass, but not allow the attacker to enter a building or vehicle. Glass system 300 in FIG. 3, in one aspect of an embodiment of the present invention, may comprise of a 6 mm Shooter Attack glass which has a significant increase in performance compared to a standard polyvinyl butyral (PVB) interlayer. Shooter Attack Stack Glass system 300 passed Class 8 at 225 ft-lbs of energy using 6 mm glass, while standard PVB passed Class 5 at 150 ft-lbs of energy using 8.5 mm glass at room temperature. That shows a 43% increase in performance by using glass system 300 which is thinner than current technology. Table 3, above, shows the cold temperature report for the shooter attack test. Even at cold temperatures, Shooter Attack Stack Glass system 300 passed Class 8 at 225 ft-lbs of energy where the current products will fail on the first hit at 50 ft-lbs of energy.

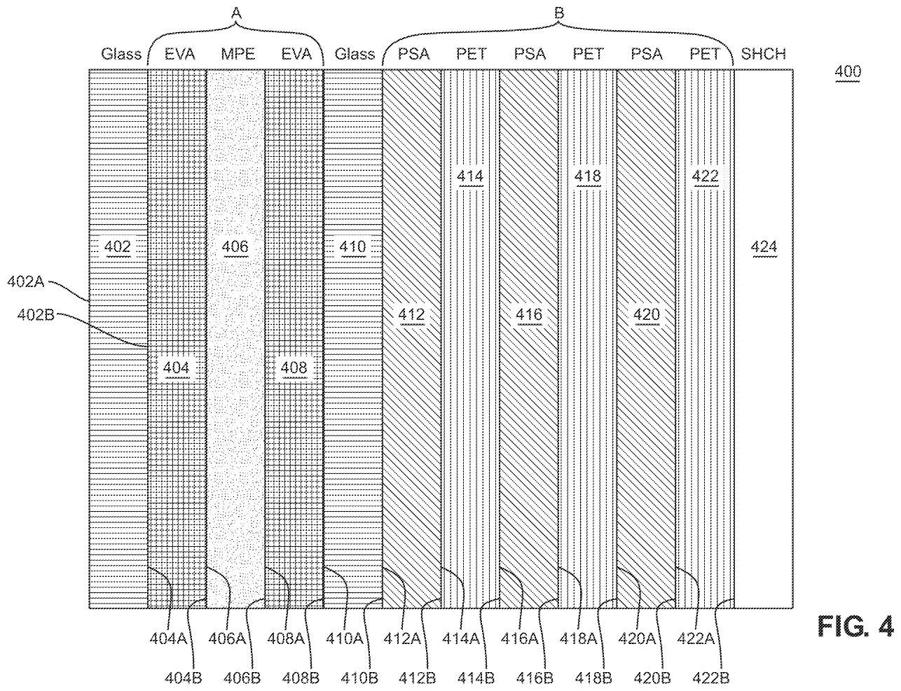

Referring now to FIG. 4, a multi-layered protective glass system or Hurricane and Impact Resistance Stack glass system 400 is shown according to aspects of an embodiment of the present invention. Multi-layered protective glass system 400 may include first layer of glass 402 which may have first and second sides 402A, 402B. Glass system 400 may also include first hybrid interlayer A, which may include first and second layers of ethylene vinyl acetate (EVA), 404, 408, and a layer of modified polyethylene (MPE) 406. Each of these layers may include first and second sides 404A and 404B (for first ethylene vinyl acetate (EVA) layer 404); first and second sides 406A and 406B (for modified polyethylene (MPE) layer 406); and first and second sides 408A, 408B (for second ethylene vinyl acetate (EVA) layer 408). In an aspect of an embodiment of the present invention, modified polyethylene (MPE) layer 406 may be interposed between ethylene vinyl acetate (EVA) layers 404 and 408. In an aspect of an embodiment of the present invention, second side 402B of first layer of glass 402 may be superimposed on the first side of the first hybrid interlayer A, where the first side of first hybrid interlayer A is formed by first side 404A of ethylene vinyl acetate layer 404.

Glass system 400 may also include second layer of glass, 410 comprising of first and second sides (410A and 410B), where the second side of the first hybrid interlayer A, (as formed by second side 408B of second ethylene vinyl acetate (EVA) layer 408) may be superimposed on the first side 410A of second layer of glass 410.

Anti-spalling layer, B of glass system 400 may include first, second and third pressure sensitive adhesive layers 412, 416 and 420 and first, second and third polyethylene terephthalate (PET) layers 414, 418 and 422.

In an aspect of an embodiment of the present invention, second side 410B of glass layer 410 may be superimposed on a first side of anti-spalling layer, B of glass system 400 where the first side of anti-spalling layer B may be formed by first side 412A of first pressure sensitive adhesive layer 412.

In an aspect of an embodiment of the present invention, second side 412B of first pressure sensitive adhesive (PSA) layer 412 may be superimposed on first side 414A of first polyethylene terephthalate (PET) layer 414, which in turn, by way of second side 414B of first polyethylene terephthalate (PET) layer 414, may be superimposed on first side 416A of second pressure sensitive adhesive (PSA) layer 416. Second pressure sensitive adhesive (PSA) layer 416, by way of second side 416B of pressure sensitive adhesive layer (PSA) layer 416, may be superimposed on first side 418A of second polyethylene terephthalate (PET) layer 418, which in turn, by way of second side 418B, may be superimposed on first side 420A of third pressure sensitive adhesive (PSA) layer 420, Third pressure sensitive adhesive (PSA) layer 420, may be superimposed on first side 422A of third polyethylene terephthalate (PET) layer 422.

In an aspect of an embodiment of the present invention, glass system 400 may further comprise of self-healing surface coat (SHSC) layer 424, which, in an aspect of an embodiment of the present invention, may superimposed on the second side of anti-spalling layer B of glass system 400 as formed by second side 422B of third polyethylene terephthalate (PET) layer 422.

In an aspect of an embodiment of the present invention, any one or more of glass layers 402, 410 may be any one of: heat strengthened glass, tempered glass.

An exemplary, non-limiting aspect of an embodiment of the present invention contemplates a glass system 400 as shown in FIG. 4 with layers having the following exemplary, and non-limiting compositions, configurations, and thicknesses:
Layer 1 (402): 2.0 mm=Heat Strengthened/Tempered Glass (up to 8 mm thick)
Layer 2 (404): 0.2 mm=Hybrid Interlayer Pt 1—Ethylene Vinyl Acetate EVA (up to 1 mm thick)
Layer 3 (406): 0.2 mm=Hybrid Interlayer Pt 2—Modified Polyethylene MPE (up to 1 mm thick)
Layer 4 (408): 0.2 mm=Hybrid Interlayer Pt 3—Ethylene Vinyl Acetate EVA (up to 1 mm thick)
Layer 5 (410): 2.0 mm=Heat Strengthened/Tempered Glass (up to 8 mm thick)
Layer 6 (412): Pressure Sensitive Adhesive
Layer 7 (414): 7 mil Polyethylene Terephthalate PET (or other polymers)
Layer 8 (416): Pressure Sensitive Adhesive
Layer 9 (418): 7 mil Polyethylene Terephthalate PET (or other polymers)
Layer 10 (420): Pressure Sensitive Adhesive
Layer 11 (422): 7 mil Polyethylene Terephthalate PET (or other polymers)
Layer 12 (424): Self-Healing/Anti-Scratch Surface Hard Coat

The purpose of the above non-limiting design is to take repeated hits from impacts of a 2″×4″ piece based on Miami Dade Impact Requirements². The Hybrid interlayer A holds the glass in place due to the superior adhesion that is required for multiple impacts at extreme pressures. The glass layers (402 & 410) in Layers 1 and 5 are meant to dissipate the energy from the impacts as it breaks down. The rest of the layers create an anti-spall protection for building inhabitants. ² The Miami Dade Impact Requirements represents one of the highest impact ratings for hurricanes and tornadoes.

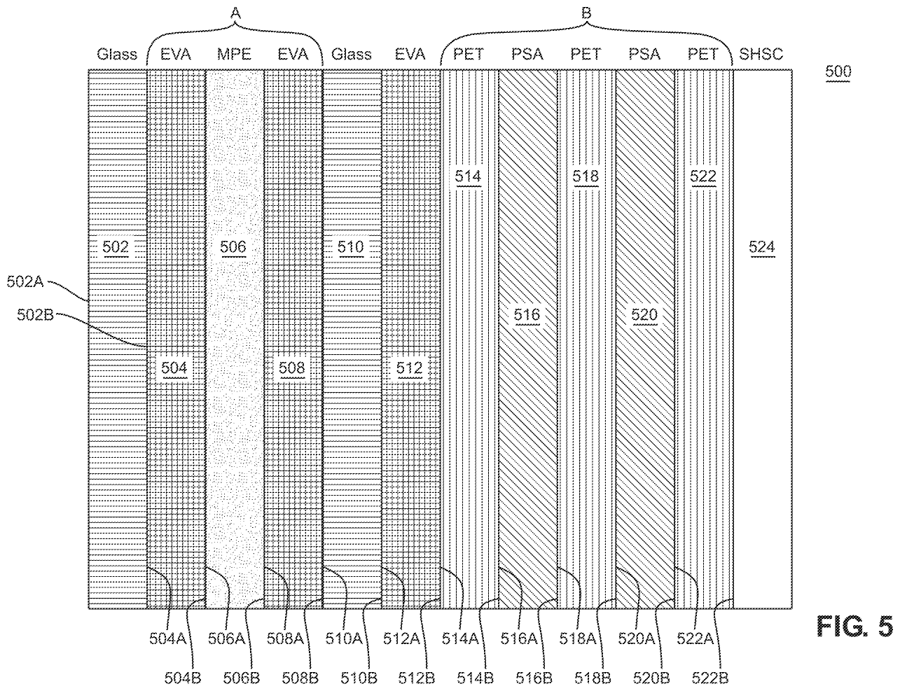

Referring now to FIG. 5, multi-layered protective glass system or All-In-One Bake Stack glass system 500 is shown according to aspects of an embodiment of the present invention. Multi-layered protective glass system 500 may include first layer of glass 502 which may have first and second sides 502A, 502B. Glass system 500 may also include first hybrid interlayer A, which may include first and second layers of ethylene vinyl acetate (EVA), 504, 508, and modified polyethylene (MPE) layer 506. Each of these layers may include first and second sides 504A and 504B (for first ethylene vinyl acetate (EVA) layer 504); first and second sides 506A and 506B (for modified polyethylene (MPE) layer 506); and first and second sides 508A, 508B (for second ethylene vinyl acetate (EVA) layer 508). In an aspect of an embodiment of the present invention, modified polyethylene (MPE) layer 506 may be interposed between ethylene vinyl acetate (EVA) layers 504 and 508. In an aspect of an embodiment of the present invention, second side 502B of first layer of glass 502 may be superimposed on the first side of the first hybrid interlayer A, where the first side of first hybrid interlayer A is formed by first side 504A of ethylene vinyl acetate layer 504.

Glass system 500 may also include second glass layer 510 comprising of first and second sides (510A and 510B), where the second side of the first hybrid interlayer A, (as formed by second side 508B of second ethylene vinyl acetate (EVA) layer 508) may be superimposed on first side 510A of second glass layer 510. Glass system 500 may also include anti-spalling layer B which may include multiple layers, including first, second and third polyethylene terephthalate (PET) layers 514, 518 and 522 and first and second pressure sensitive adhesive layers 516 and 520, with each layer respectively having first and second sides.

In an aspect of an embodiment of the present invention, glass system 500 may further include ethylene vinyl acetate (EVA) layer 512, which, in an aspect of an embodiment of the present invention, may be interposed between second glass layer 510 and anti-spalling layer B of glass system 500.

In an aspect of an embodiment of the present invention, first side 512A of ethylene vinyl acetate (EVA) layer 512 may be superimposed on second side 510B of second glass layer 510 while second side 512B of ethylene vinyl acetate (EVA) layer 510 may be superimposed on first side 514A of first polyethylene terephthalate (PET) layer 514.

Second side 514B of polyethylene terephthalate (PET) layer 514 may be superimposed on first side 516A of first pressure sensitive adhesive layer 516. In an aspect of an embodiment of the present invention, second side 516B of first pressure sensitive adhesive (PSA) layer 516 may be superimposed on first side 518A of first polyethylene terephthalate (PET) layer 518, which in turn, by way of second side 518A of polyethylene terephthalate (PET) layer 518, may be superimposed on first side 520A of second pressure sensitive adhesive (PSA) layer 520 Second pressure sensitive adhesive (PSA) layer 520, by way of second side 520B of second pressure sensitive adhesive (PSA) layer 520, may be superimposed on first side 522A of third polyethylene terephthalate (PET) layer 522.

In an aspect of an embodiment of the present invention, glass system 500 may further comprise of self-healing surface coat (SHSC) layer 524, which, in an aspect of an embodiment of the present invention, may superimposed on the second side of anti-spalling layer B of glass system 500 as formed by second side 522B of third polyethylene terephthalate (PET) layer 522.

In another aspect of an embodiment of the present invention, any one or both of the first and second glass layers 502, 510 may be any one of: annealed glass, heat strengthened glass, tempered glass.

An exemplary, non-limiting aspect of an embodiment of the present invention contemplates a glass system 500 as shown in FIG. 5 with layers having the following exemplary, and non-limiting compositions, configurations, and thicknesses:
Layer 1 (502): 2.0 mm=Annealed/Heat Strengthened/Tempered Glass (up to 8 mm thick)
Layer 2 (504): 0.2 mm=Hybrid Interlayer Pt 1—Ethylene Vinyl Acetate EVA (up to 1 mm thick)
Layer 3 (506): 0.2 mm=Hybrid Interlayer Pt 2—Modified Polyethylene MPE (up to 1 mm thick)
Layer 4 (508): 0.2 mm=Hybrid Interlayer Pt 3—Ethylene Vinyl Acetate EVA (up to 1 mm thick)
Layer 5 (510): 2.0 mm=Annealed/Heat Strengthened/Tempered Glass (up to 8 mm thick)
Layer 6 (512): 0.2 mm=Ethylene Vinyl Acetate EVA
Layer 7 (514): 7 mil Polyethylene Terephthalate PET
Layer 8 (516): Pressure Sensitive Adhesive
Layer 9 (518): 7 mil Polyethylene Terephthalate PET
Layer 10 (520): Pressure Sensitive Adhesive
Layer 11 (522): 7 mil Polyethylene Terephthalate PET
Layer 12 (524): Self-Healing/Anti-Scratch Surface Hard Coat

The purpose of the design is to take repeated hits from impacts of a 2″×4″ piece based on the Miami Dade Impact Requirements. It should be noted that the All-in-One bake stack is not limited to 2 layers of glass, as many layers as needed can be used in this process with extended lamination times.

Operation

Layer 1 (first glass layer 502) would break up the first bullet depending on the caliber in a shooting situation. Alternatively, layer 1 may be the barrier to the first several hits of an object/blunt force weapon such a bat or wrench. The glass can be customized based on optical, thermal, and mechanical specifications. The primary purpose of the two-layer stack is to allow the bullet to pass through but remain intact after blunt impacts. Layers 2-4 is hybrid interlayer A which is specifically designed to absorb and repel energy when it is attacked. The high Young's modulus of interlayer A is essential to slow the bullet's mass as it dissipates energy against a blunt object's attack. Layer 5 (second glass layer 510) is the second layer of glass that keeps the laminated structure intact while letting the bullet pass through. Layers 6 (EVA layer 512) is the polymer layer that acts as a bonding agent for the surface applied film and the glass. This creates a watertight bond that also has very good sound insulation. Layers 7-11 is part of a three-layer polyethylene terephthalate film combined with a polymeric pressure sensitive adhesive. This acts as an anti-spalling system B that is meant to keep the glass intact in an attack and not harming the occupants on the other side of the glass. The film is also bomb blast rated (depending on the framing) and used as the last line of defense to keep the glass from blowing inwards after a bullet is shot and a bat or other blunt instruments being swung at the window multiple times. Layer 12 (layer 524) is a cosmetic layer designed to be a durable scratch resistant coating and can be customized to be self-healing as well. The glasses used in the invention can be customized for various optical, thermal, and mechanical properties for different applications. Because the system has multiple layers of glass and polymeric materials, the ultra-violet light absorption will be 99.9% due to the hybrid interlayer and have a much higher thermal insulation compared to the contemporary design shown in FIG. 6. The acoustics for sound should theoretically be significantly better than a single layer tempered or three-layer laminated glass as well. This system has even better anti-spalling than the other stacks and allows the glass to be significantly thinner than the other compositions due to the very high Young's modulus of the stack.

Testing & Test Results

A sampling of tests and test results for the above non-limiting aspects of embodiments of the All-in-One bake stack glass system 500 of the present invention was conducted and is outlined in the accompanying testing results.

### Materials

### Test Piece Features

Frame: Wood with VHB Tape
Glazing: Hybrid ¼″ Laminated glass and 23 MIL Shooter Attack Film

### Gun Type: AR-15

### Bullet Type: Remington 0.223 Bullets

### Climate

### Range Temp.: 65 DEGREES FAHRENHEIT

### Glass Surface Temperature: 60 DEGREES FAHRENHEIT

### Procedure

### FTD-SA Standard

The glass was placed in the wooden frames with VHB tape on both sides of the frame to anchor the glass. The film side of the laminated glass was considered the “safe” side. The frame was anchored with three screws on each side to keep the glass and wood together. The glass was then shot in the predetermined pattern in accordance with the FTD-SA testing standard.

A failure is either when the glass and film is punctured through with the head of the ram.

TABLE 4
TEST RESULTS DATA

| CLASS | FT/LBS | HIT # | PASS/FAIL |
|---|---|---|---|
| 1 | 50 | 1 | PASS |
| 1 | 50 | 2 | PASS |
| 2 | 75 | 1 | PASS |
| 2 | 75 | 2 | PASS |
| 3 | 100 | 1 | PASS |
| 3 | 100 | 2 | PASS |
| 4 | 125 | 1 | PASS |
| 4 | 125 | 2 | PASS |
| 5 | 150 | 1 | PASS |
| 5 | 150 | 2 | PASS |
| 6 | 175 | 1 | PASS |
| 6 | 175 | 2 | PASS |
| 7 | 200 | 1 | PASS |
| 7 | 200 | 2 | PASS |
| 8 | 225 | 1 | PASS |
| 8 | 225 | 2 | PASS |
| 9 | 250 | 1 | PASS |
| 9 | 250 | 2 | PASS |
| 10 | 275 | 1 | PASS |
| 10 | 275 | 2 | PASS |
| 11 | 300 | 1 | PASS |
| 11 | 300 | 2 | PASS |
| 12 | 325 | 1 | PASS |
| 12 | 325 | 2 | FAIL |

### Summary

### Testing was Completed on Following:

### FRAME: WOOD WITH VHB TAPE

### GLAZING: HYBRID ¼″ LAMINATED GLASS AND 23 MIL SHOOTER ATTACK FILM

THE RESULTS SHOW THAT THE GLASS FAILED ON THE SECOND HIT OF CLASS 12 AT 325 FT/LBS OF ENERGY. ¼″ LAMINATE PASSED CLASS 11 AT 300 FT-LBS OF ENERGY UTILIZING THE HYBRID FLEX ARMOURED COMPOSITE (All-in-One bake stack glass system 500).

A further aspect of an embodiment of the present invention contemplates a multi-layered protective glass system, comprising: at least one layer of glass (such as glass layer 502), a hybrid interlayer A, comprising of first and second sides, where a first layer of said at least one layer of glass may be superimposed on the first side of the hybrid interlayer, a second layer of said at least one layer of glass, comprising of first and second sides, where the second side of the hybrid interlayer may be superimposed on the first side of the second layer of said at least one layer of glass, a layer of ethylene vinyl acetate (EVA), comprising of first and second sides, where the second side of the second layer of glass may be superimposed on the first side of the layer of ethylene vinyl acetate (EVA), an anti-spalling layer, comprising of first and second sides, where the second side of the layer of ethylene vinyl acetate (EVA) may be superimposed on the first side of the anti-spalling layer, and a layer of self-healing surface coat (SHSC), where the layer of SHSC may be superimposed on the second side of the anti-spalling layer.

The 3-part hybrid interlayers are designed to create a watertight bond to the glass surfaces that can interchange different polymers for different applications. This bond creates a very high impact resistant interlayer that is stiff enough to not break upon impact but elongate enough to absorb a significant amount of energy upon impact. Each glass layer plays a specific roll for ballistic and impact resistance.

The glass for each of the stacks can be interchanged with any desired type of glass. The different types of glass layers offer different layers of protection. Tempered glass is made for accidental bumps and a single large impact because once the surface is broken and the energy dissipates, it becomes useless. Annealed glasses like borosilicate, soda lime silica, and others break easier, but stay strong even after breaking when it is used in a laminated glass. Each one of the stacks utilize different types of glass for the desired needs like ballistic, impact, and shooter attack ratings.

Non-limiting aspects of embodiments of the present invention also contemplate individual glass layer thicknesses having a range between 0.7 mm to 6.5 mm thick. Aspects of embodiments of the present invention also contemplate hybrid interlayers also having various interchangeable thicknesses ranging from 0.2 mm to 0.78 mm for different applications and specifications.

Referring now to FIG. 6, a current glass system 600 is shown. As shown, current glass systems include one or two layers of glass with an interposed layer of PVB. Current systems may also include a layer of Polymeric PET Film with Sensitive Adhesives superimposed on one of the glass layers. However, this system also bears the disadvantages associated with the use of PVB as previously discussed, including the fact that polyvinyl butyral (PVB) and polycarbonate (PCB) based glass systems become mechanically, optically, and thermally unstable after a couple years. In addition, there is the potential for delamination of the PVB interlayer.

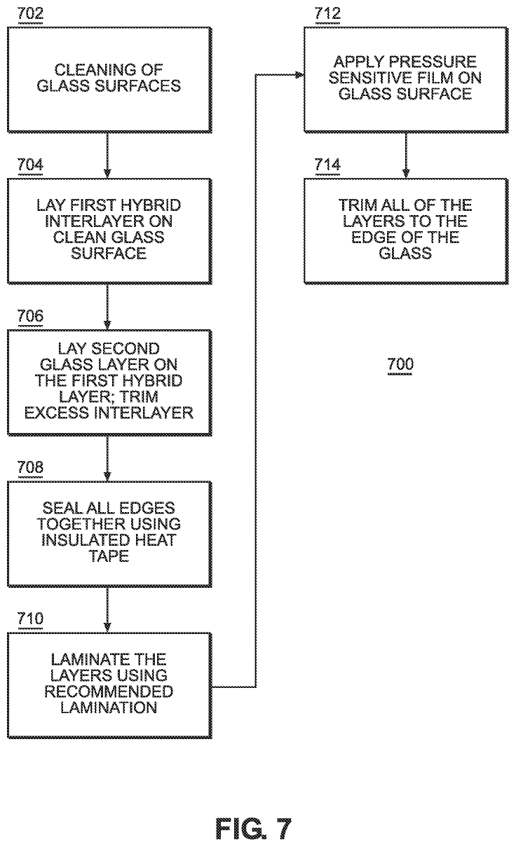

Referring now to FIG. 7, a manufacturing process 700 for manufacturing Shooter Attack/Basic Automatic Stack Multi-layered Protective Glass System 300 is shown according to an aspect of an embodiment of the present invention. Process 700 begins with step 702 with the cleaning of glass layer surfaces, where the glass layers are used in the multi-layered protective glass system. In an aspect of an embodiment of the present invention, this may be done with the use of isopropanol and a microfiber towel.

Next, step 702 is followed by step 704 with the laying of a first hybrid interlayer on the clean first glass layer or surface. Next, in step 706, a second layer of glass is laid on top of the first hybrid interlayer. Also with this step, any excess interlayer may be trimmed. Next, in step 708, an insulated heat tape is used to seal all the edges together. Next, in step 710 the recommended lamination process is used to laminate the layers. After lamination, in step 712 the desired surface applied film application is used to apply pressure sensitive film on the glass surface of the second glass layer. Lastly, in step 714 all of the layers are trimmed to the edge of the glass for a clean edge.

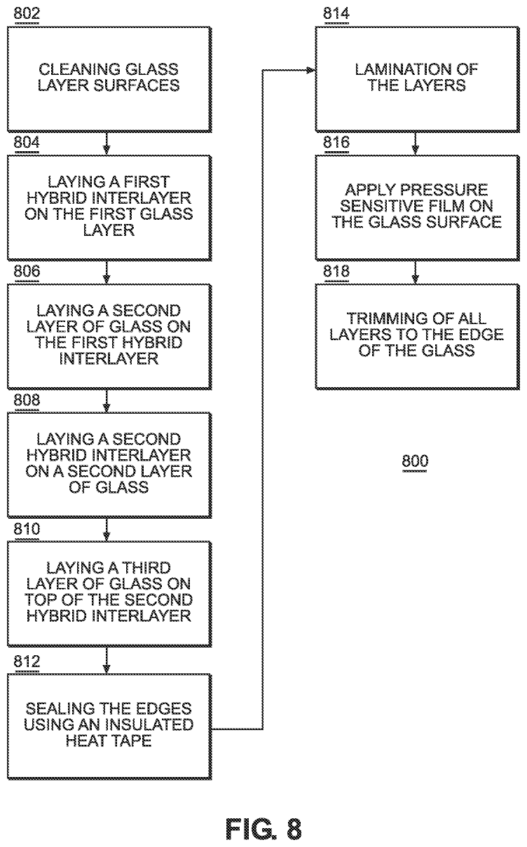

Referring now to FIG. 8, a manufacturing process 800 for manufacturing Bullet Resistant Stack Multi-layered Protective Glass System 100 is shown according to an aspect of an embodiment of the present invention. Process 800 begins with step 802 where both sides of the glass surfaces to be used are cleaned. This may be done by using isopropanol and a microfiber towel.

Next, in step 804 a 3-part interlayer (or hybrid layer) is laid on the clean glass surface. This step is followed by step 806 where a second layer of glass is laid on top of the 3-part interlayer and any excess 3-part interlayer is trimmed. Next, in step 808 a 2nd 3-Part interlayer is laid on the clean glass surface. This is followed by step 810 where a third layer of glass is laid on top of the 3-part Hybrid interlayer and any excess interlayer is trimmed.

Next, in step 812 an insulated heat tape is used to seal all the edges together, and, in step 814 the recommended proprietary lamination process is used to laminate the layers. After lamination, in step 816 the desired surface applied film application is used to apply pressure sensitive film on the surface of the glass of the second glass layer. Finally, in step 818 all layers are trimmed to the edge of the glass for a clean edge.

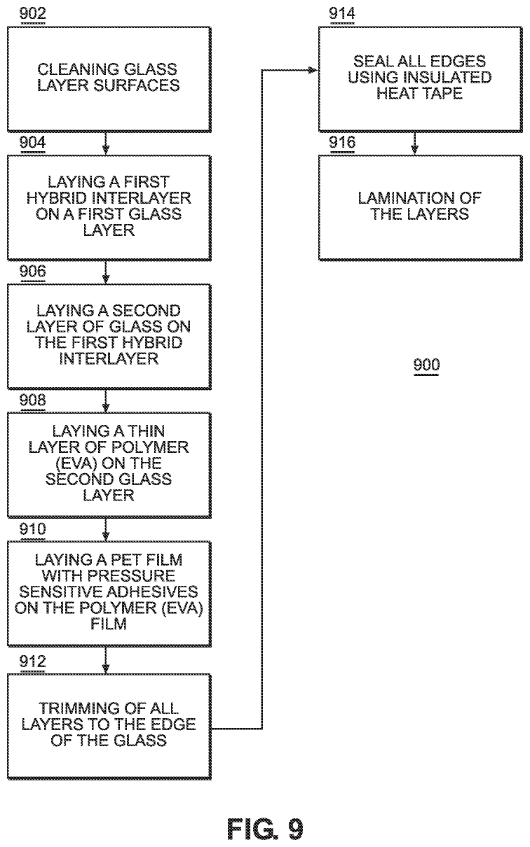

Referring now to FIG. 9, a manufacturing process 900 for manufacturing All-In-One Stack Glass System 500 is shown according to aspects of embodiments of the present invention. Process 900 begins with step 902 where both sides of the glass surfaces to be used are cleaned. This may be done by using isopropanol and a microfiber towel. Next, in step 904 a 3-part interlayer (i.e., hybrid interlayer) is laid on the clean glass surface. Next, in step 906 a second layer of glass is laid on top of the 3 Part Interlayer and any excess 3 Part Interlayer is trimmed.

Next, in step 908 a thin layer of polymer film (EVA) is placed on the second glass surface. Then, in step 910 a PET film with Pressure Sensitive Adhesives (PSA) is laid on the thin layer of polymer film. Next, in step 912, all layers are trimmed to the edge of the glass for a clean edge. Next in step 914 an insulated heat tape is used to seal all the edges together. Finally, in step 916 the recommended proprietary lamination process is used to laminate the layers.

The glass systems as disclosed by aspects of embodiments of the present invention are unconventional because for every stack that is shown or discussed above, they are significantly thinner than every single stack that is currently available on the market. For instance, the Shooter Attack Stack Glass System is the first of its kind because it is designed to be shot and impacted with a massive amount of force from a 100 lbs ram for existing frames in buildings and vehicles. For hurricane and other impact stacks, the Hybrid utilizes its superior bonding to the glass surface to keep the glass from delaminating after the impacts. This allows a thinner stack to be designed which then means less energy is used to manufacture a far superior interlayer and laminated glass stack. The water resistance of the interlayer of the laminated glass stacks is significantly higher than any interlayer on the market as well because of the EVA material that sandwiches the MPE in the middle. This allows open edge laminated stacks that no longer require extra sealings which further decreases the amount of material and energy needed to manufacture the final product.

The manufacturing process for all of the stacks using the Hybrid interlayer allow the glass makeups to be thinner than any laminated glass on the market while increasing security ratings for bullet resistance, hurricane, Shooter Attack, and more. Because of the thinness of the stacks, manufacturing the glass requires less energy due to the low melting temperatures, no requirements for climate-controlled rooms, and natural water resistance. All of that means the invention is much better for the environment and the cost of manufacturing decreases while producing security glass stacks that are affordable.

Each layer can be manipulated by changing the thicknesses and composition of each layer. The layers can possibly be rearranged depending on the applications. The process itself can be done using existing an autoclave or a vacuum lamination oven. The invention can fit into most existing passenger vehicles and framing without having to manipulate the door frames to fit the thickness of the window glass. All of the glass stacks above are not limited to any type of framing. It should also be noted that the maximum thickness of the individual layers of each system may be changed for different applications, to stop different types of bullets etc. By changing the thickness of individual glass layers, the resistance against high caliber bullet is increased.

It will also be evident that while exemplary applications of the contemplated protective glass system have been discussed in this disclosure (e.g., automotive, buildings, architectural structures etc.), the contemplated protective glass system may also be used in various other applications where glass configuration systems and/or where glass is used including, without limitation, aviation, rail, shipping etc.

Although this present invention has been disclosed with reference to specific forms and embodiments, it will be evident that a great number of variations may be made without departing from the spirit and scope of the present invention. For example, layering configurations may be reversed and/or rearranged, the layer thicknesses may be changed or varied, equivalent elements may be substituted for those specifically disclosed and certain features of the present invention may be used independently of other features—all without departing from the present invention as outlined above, in the appended figures and the claims presented below.

What is claimed is:

1. A multi-layered protective glass system, comprising:
a first layer of glass;
a first hybrid interlayer, comprising of first and second sides, wherein the first layer of glass is superimposed on the first side of the first hybrid interlayer;
a second layer of glass, comprising of first and second sides, wherein the second side of the first hybrid interlayer is superimposed on the first side of the second layer of glass;
a second hybrid interlayer, comprising of first and second sides, wherein the second side of the second layer of glass is superimposed on the first side of the second hybrid interlayer;
a third layer of glass, comprising of first and second sides, wherein the second side of the second hybrid interlayer is superimposed on the first side of the third layer of glass; and
an anti-spalling layer, comprising of first and second sides, wherein the second side of the third layer of glass is superimposed on the first side of the anti-spalling layer.

2. The multi-layered protective glass system of claim 1, wherein the first hybrid interlayer comprises of two layers of ethylene vinyl acetate (EVA), and a layer of modified polyethylene (MPE).

3. The multi-layered protective glass system of claim 2, wherein the layer of modified polyethylene is interposed between the two layers of ethylene vinyl acetate (EVA).

4. The multi-layered protective glass system of claim 1, wherein the second hybrid interlayer comprises of two layers of ethylene vinyl acetate (EVA), and a layer of modified polyethylene (MPE).

5. The multi-layered protective glass system of claim 4, wherein the layer of modified polyethylene is interposed between the two layers of ethylene vinyl acetate (EVA).

6. The multi-layered protective glass system of claim 1, wherein the anti-spalling layer comprises of: first, second and third layers of pressure sensitive adhesive and first, second and third layers of polyethylene terephthalate (PET).

7. The multi-layered protective glass system of claim 6 wherein the first layer of pressure sensitive adhesive (PSA) is superimposed on the first layer of polyethylene terephthalate (PET), which in turn is superimposed on the second layer of pressure sensitive adhesive (PSA), which in turn is superimposed on the second layer of polyethylene terephthalate (PET), which in turn is superimposed on the third layer of pressure sensitive adhesive, which in turn is superimposed on the third layer of polyethylene terephthalate (PET), wherein a portion of the first layer of pressure sensitive adhesive forms the first side of the anti-spalling layer and a portion of the third layer of polyethylene terephthalate (PET) forms the second side of the anti-spalling layer.

8. The multi-layered protective glass system of claim 1, further comprising a layer of ethylene vinyl acetate (EVA), wherein the layer of ethylene vinyl acetate (EVA) is interposed between the 3^{rd} glass layer and the anti-spalling layer.

9. The multi-layered protective glass system of claim 1, further comprising a layer of self-healing surface coat (SHSC), wherein the layer of SHSC is superimposed on the second side of the anti-spalling layer.

10. The multi-layered protective glass system of claim 1, wherein any one or more of the first, second and third layers of glass is any one of: borosilicate glass, annealed glass, heat strengthened glass, tempered glass.

11. A multi-layered protective glass system, comprising:
a first layer of glass;
a hybrid interlayer, comprising of first and second sides, wherein the first layer of glass is superimposed on the first side of the hybrid interlayer;
a second layer of glass, comprising of first and second sides, wherein the second side of the hybrid interlayer is superimposed on the first side of the second layer of glass;
an anti-spalling layer, comprising of first and second sides, wherein the second side of the second layer of glass is superimposed on the first side of the anti-spalling layer; and
a layer of self-healing surface coat (SHSC), wherein the layer of SHSC is layered on the second side of the anti-spalling layer.

12. The multi-layered protective glass system of claim 11, wherein the anti-spalling layer comprises of: first, second and third layers of pressure sensitive adhesive (PSA) and first, second and third layers of polyethylene terephthalate (PET), wherein a portion of the first layer of PSA forms the first side of the anti-spalling layer and wherein a portion of the third layer of PET forms the second side of the anti-spalling layer.

13. The multi-layered protective glass system of claim 11, wherein the hybrid interlayer comprises of two layers of ethylene vinyl acetate (EVA), and a layer of modified polyethylene (MPE).

14. The multi-layered protective glass system of claim 13, wherein the layer of modified polyethylene is interposed between the two layers of ethylene vinyl acetate (EVA).

15. The multi-layered protective glass system of claim 12, wherein the first layer of pressure sensitive adhesive is superimposed on the first layer of polyethylene terephthalate (PET), which in turn is superimposed on the second layer of pressure sensitive adhesive, which in turn is superimposed on the second layer of polyethylene terephthalate (PET), which in turn is superimposed on the third layer of pressure sensitive adhesive, which in turn is superimposed on the third layer of polyethylene terephthalate (PET).

16. The multi-layered protective glass system of claim 11, wherein any one or both of the first and second layers of glass is any one of: borosilicate glass, annealed glass, heat strengthened glass, tempered glass.

17. A multi-layered protective glass system, comprising:
at least one layer of glass;
a hybrid interlayer, comprising of first and second sides, wherein a first layer of said at least one layer of glass is superimposed on the first side of the hybrid interlayer;
a second layer of said at least one layer of glass, comprising of first and second sides, wherein the second side of the hybrid interlayer is superimposed on the first side of the second layer of said at least one layer of glass;
a layer of ethylene vinyl acetate (EVA), comprising of first and second sides, wherein the second side of the second layer of glass is superimposed on the first side of the layer of ethylene vinyl acetate (EVA);
an anti-spalling layer, comprising of first and second sides, wherein the second side of the layer of ethylene vinyl acetate (EVA) is superimposed on the first side of the anti-spalling layer; and
a layer of self-healing surface coat (SHSC), wherein the layer of SHSC is superimposed on the second side of the anti-spalling layer.

18. The multi-layered protective glass system of claim 17, wherein the hybrid interlayer comprises of two layers of ethylene vinyl acetate (EVA), and a layer of modified polyethylene (MPE).

19. The multi-layered protective glass system of claim 18, wherein the layer of modified polyethylene is interposed between the two layers of ethylene vinyl acetate (EVA).

20. The multi-layered protective glass system of claim 17, wherein the anti-spalling layer comprises of: first, second and third layers of polyethylene terephthalate (PET), and first and second layers of pressure sensitive adhesive (PSA) and wherein a portion of the first layer of polyethylene terephthalate (PET) forms the first side of the anti-spalling layer and wherein a portion of the third layer of polyethylene terephthalate (PET) forms the second side of the anti-spalling layer.

21. A process for manufacturing a multi-layered protective glass system, comprising the steps of:
cleaning surfaces of glass layers used in the multi-layered protective glass system;
laying a first hybrid interlayer on a first glass layer or surface;
laying a second layer of glass on top of the first hybrid interlayer;
laying a second hybrid interlayer on a second glass layer or surface;
laying a third layer of glass on top of the second hybrid interlayer;
placing a thin layer of polymer film on the third layer of glass or surface; and
laying a 23-mil thick PET film with Pressure Sensitive Adhesives (PSA) on the thin layer of polymer film.

22. The manufacturing process of claim 21, further comprising the step of trimming all the layers to the edge of the glass layers for a clean edge.

23. The manufacturing process of claim 21, further comprising the step of sealing edges of the layers using an insulated heat tape.

24. A process for manufacturing a multi-layered protective glass system, comprising the steps of:
cleaning surfaces of a first glass layer used in the multi-layered protective glass system;
laying a hybrid interlayer on the first glass layer; and
laying a second glass layer on top of the first hybrid interlayer;

25. The manufacturing process of claim 24, further comprising the steps of:
trimming excess interlayer;
sealing all edges of the glass layers and the hybrid interlayer together;
laminating the glass layers and the hybrid interlayer;
using a desired surface applied film application to apply pressure sensitive film on the first glass layer's surface; and
trimming all layers of the first glass layer's edge.

26. A process for manufacturing a multi-layered protective glass system, comprising the steps of:
cleaning surfaces of a first glass layer used in the multi-layered protective glass system;
laying a first hybrid interlayer on the first glass layer;
laying a second glass layer on top of the first hybrid interlayer;
laying a second hybrid interlayer on the first glass layer; and
laying a third glass layer on top of the second hybrid interlayer;

27. The manufacturing process of claim 26, further comprising the steps of:
trimming excess interlayer;
using an insulated heat tape to seal all edges of the glass layers and hybrid interlayers together;
laminating the glass layers and hybrid interlayers;
using a desired surface applied film application to apply pressure sensitive film on the first glass layer's surface; and
trimming all layers of the first glass layer's edge.
